(19) United States
(12) Patent Application Publication
(10) Pub. No.: US 2019/0102199 A1
(43) Pub. Date: Apr. 4, 2019

(54) METHODS AND SYSTEMS FOR EXECUTING VECTORIZED PYTHAGOREAN TUPLE INSTRUCTIONS

(71) Applicant: Intel Corporation, Santa Clara, CA (US)

(72) Inventors: Roland Schulz, Portland, OR (US); Jeffrey R. Hammond, Portland, OR (US); Jesus Corbal, Portland, OR (US)

(21) Appl. No.: 15/721,842

(22) Filed: Sep. 30, 2017

(51) Int. Cl. G06F 9/38; G06F 9/30

(52) U.S. Cl. CPC G06F 9/3802; G06F 9/3016

(57) ABSTRACT

Disclosed embodiments relate generally to computer processor architecture, and, more specifically, to methods and systems for executing vectorized Pythagorean tuple instructions. In one example, a processor includes fetch circuitry to fetch an instruction having an opcode, an order, a destination identifier, and N source identifiers, N being equal to the order, and the order being one of two, three, and four, decode circuitry to decode the fetched instruction, and execution circuitry, for each element of the identified destination, to generate N squares by squaring each corresponding element of the N identified sources and generate a sum of the N squares and previous contents of the element.

### FIELD OF INVENTION

The field of invention relates generally to computer processor architecture, and, more specifically, to methods and systems for executing vectorized Pythagorean tuple instructions.

### BACKGROUND

A (e.g., hardware) processor, or set of processors, executes instructions from an instruction set, e.g., the instruction set architecture (ISA). The instruction set is the part of the computer architecture related to programming, and generally includes the native data types, instructions, register architecture, addressing modes, memory architecture, and interrupt and exception handling.

One class of mathematical operations relates to computing Pythagorean tuples, such as 2nd-order, 3rd-order, and 4th-order Pythagorean tuples. The latency encountered and the number of individual instructions used in executing Pythagorean tuple instructions can be high, reducing performance, as a minimum of N instructions sometimes need to be executed serially to calculate a Pythagorean tuple of order-N.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating processing components for executing vectorized Pythagorean tuple instructions, according to an embodiment;

FIGS. 2A-2C are block diagrams illustrating execution of a scalar Pythagorean tuple instruction, according to an embodiment;

FIG. 2A is a block diagram illustrating execution of a scalar order-2 Pythagorean tuple instruction, according to an embodiment;

FIG. 2B is a block diagram illustrating execution of a scalar order-3 Pythagorean tuple instruction, according to an embodiment;

FIG. 2C is a block diagram illustrating execution of a scalar order-4 Pythagorean tuple instruction, according to an embodiment;

FIG. 2D is a block diagram illustrating execution of a scalar order-2 Pythagorean tuple instruction, according to an embodiment;

FIG. 2E is a block diagram illustrating execution of a scalar order-3 Pythagorean tuple instruction, according to an embodiment;

FIG. 2F is a block diagram illustrating a circuit to execute a 4-way addition, according to an embodiment;

FIG. 2G is a block diagram illustrating a circuit to execute a 4-way addition, according to an embodiment;

FIG. 2H is a block diagram illustrating a circuit to execute a 4-way addition, according to an embodiment;

FIG. 3A is a block diagram illustrating processing components for executing vectorized order-2 Pythagorean tuple instructions, according to some embodiments;

FIG. 3B is a block diagram illustrating processing components for executing vectorized order-3 Pythagorean tuple instructions, according to some embodiments;

FIG. 3C is a block diagram illustrating processing components for executing vectorized order-4 Pythagorean tuple instructions, according to some embodiments;

FIG. 4A is a block diagram illustrating processing components for executing vectorized order-2 Pythagorean tuple instructions, according to some embodiments;

FIG. 4B is a block diagram illustrating processing components for executing vectorized order-3 Pythagorean tuple instructions, according to some embodiments;

FIG. 4C is a block diagram illustrating processing components for executing vectorized order-4 Pythagorean tuple instructions, according to some embodiments;

FIG. 5 illustrates pseudocode for executing vectorized Pythagorean tuple instructions, according to some embodiments

FIG. 6 is a block flow diagram of a process performed by a processor to execute a vectorized Pythagorean tuple instruction, according to an embodiment;

FIG. 7A is a block diagram illustrating a format for vectorized Pythagorean tuple instructions, according to some embodiments;

FIG. 7B is a block diagram illustrating an exemplary specific vector friendly instruction format according to embodiments of the invention;

FIG. 7C is a block diagram illustrating the fields of the specific vector friendly instruction format that make up the full opcode field according to one embodiment of the invention;

FIG. 7D is a block diagram illustrating the fields of the specific vector friendly instruction format that make up the register index field according to one embodiment of the invention;

FIG. 8 is a block diagram of a register architecture according to one embodiment of the invention;

FIG. 9A is a block diagram illustrating both an exemplary in-order pipeline and an exemplary register renaming, out-of-order issue/execution pipeline according to embodiments of the invention;

FIG. 9B is a block diagram illustrating both an exemplary embodiment of an in-order architecture core and an exemplary register renaming, out-of-order issue/execution architecture core to be included in a processor according to embodiments of the invention;

FIGS. 10A-B illustrate a block diagram of a more specific exemplary in-order core architecture, which core would be one of several logic blocks (including other cores of the same type and/or different types) in a chip;

FIG. 10A is a block diagram of a single processor core, along with its connection to the on-die interconnect network and with its local subset of the Level 2 (L2) cache, according to embodiments of the invention;

FIG. 10B is an expanded view of part of the processor core in FIG. 10A according to embodiments of the invention;

FIG. 11 is a block diagram of a processor that may have more than one core, may have an integrated memory controller, and may have integrated graphics according to embodiments of the invention;

FIGS. 12-15 are block diagrams of exemplary computer architectures;

FIG. 12 shows a block diagram of a system in accordance with one embodiment of the present invention;

FIG. 13 is a block diagram of a first more specific exemplary system in accordance with an embodiment of the present invention;

FIG. 14 is a block diagram of a second more specific exemplary system in accordance with an embodiment of the present invention;

FIG. 15 is a block diagram of a System-on-a-Chip (SoC) in accordance with an embodiment of the present invention; and

FIG. 16 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Detailed herein are embodiments that execute an order-2, order-3, or order-4 Pythagorean tuple instruction with a single instruction. One class of mathematical operations relates to computing Pythagorean tuples, such as illustrated below in Equations 1, 2, and 3, for 2nd-order, 3rd-order, and 4th-order Pythagorean tuples, respectively.

r=x*x+y*y (Order-2) Equation 1

r=x*x+y*y+z*z (Order-3) Equation 2

r=w*w+x*x+y*y+z*z (Order-4) Equation 3

Disclosed embodiments do not use conventional circuitry, and thus avoid having to issue multiple instructions or incur large latencies. Rather, disclosed embodiments utilize hardware to calculate the tuples in a single instruction.

### Exemplary Hardware to Execute the VPYTH Instruction

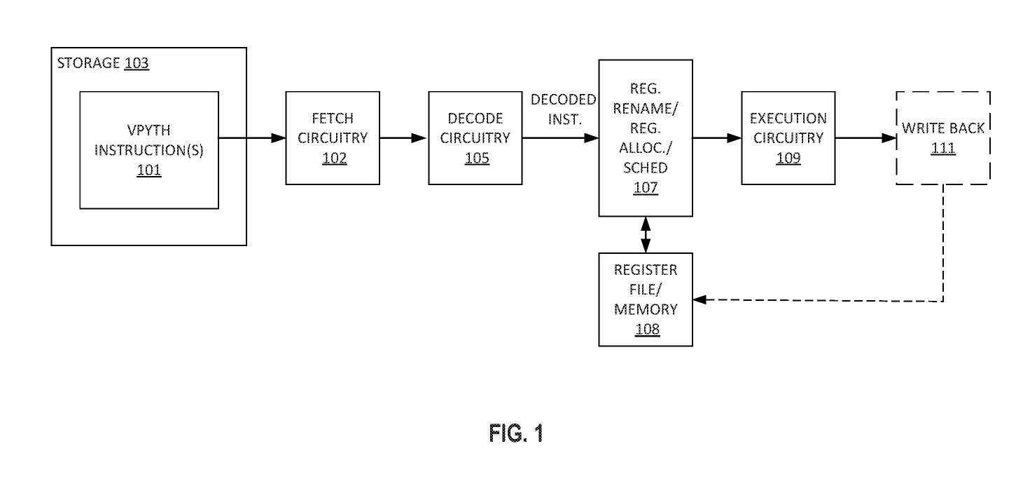

FIG. 1 is a block diagram illustrating processing components for executing Pythagorean tuple, according to an embodiment. As illustrated, storage 103 stores a VPYTH instruction(s) 101 to be executed. The instruction is received by decode circuitry 105. For example, the decode circuitry 105 receives this instruction from fetch circuitry 102. The instruction 101 includes fields for an opcode (such as VPYTH), a destination identifier, a first source identifier, a second source identifier, and an order. In some embodiments, the source[s] and destination are registers, and in other embodiments one or more are memory locations. The instruction can optionally include additional operands, and more detailed embodiments of at least one instruction format will be detailed later. The decode circuitry 105 decodes the instruction into one or more operations. In some embodiments, this decoding includes generating a plurality of micro-operations to be performed by execution circuitry (such as execution circuitry 109). The decode circuitry 105 also decodes instruction prefixes (if used).

In some embodiments, register renaming, register allocation, and/or scheduling circuitry 107 provides functionality for one or more of: 1) renaming logical operand values to physical operand values (e.g., a register alias table in some embodiments), 2) allocating status bits and flags to the decoded instruction, and 3) scheduling the decoded instruction for execution on execution circuitry out of an instruction pool (e.g., using a reservation station in some embodiments).

Registers (such as included in register architecture 800, described below) and/or memory 108 store data as operands of the instruction to be operated on by execution circuitry. Exemplary register types include packed data registers, general purpose registers, and floating point registers.

Execution circuitry 109 executes the decoded VPYTH instruction. Exemplary detailed execution circuitry is described further below. In an embodiment of a vectorized operation, the execution of the decoded VPYTH instruction the execution circuitry to execute the decoded instruction on each of a plurality of corresponding pairs of elements of first and second source vectors, the execution to generate a first product by multiplying the first element by itself, generate a second product by multiplying the second element by itself, and accumulate the first and second products with previous contents of the destination.

Write back (retirement) circuitry 111 commits the result of the execution of the decoded VPYTH instruction. Write back (retirement) circuitry 111 is optional, as indicated by its dashed border, at least insofar as it represents functionality that can occur at a different time, at a different stage of the processor's pipeline, or not at all.

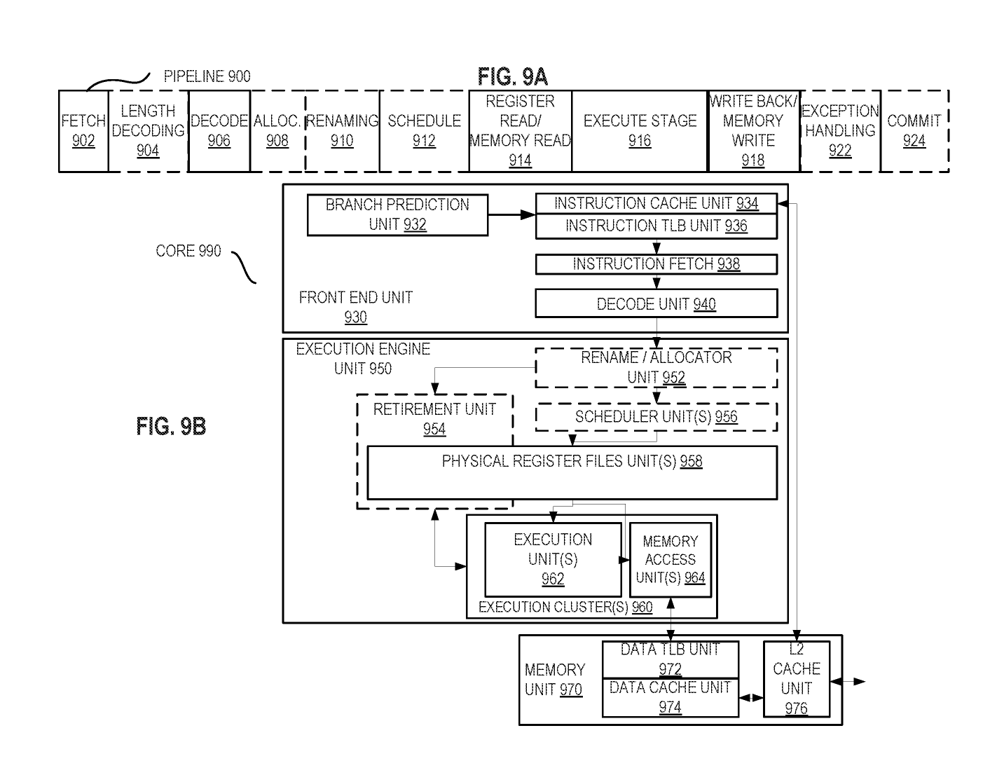

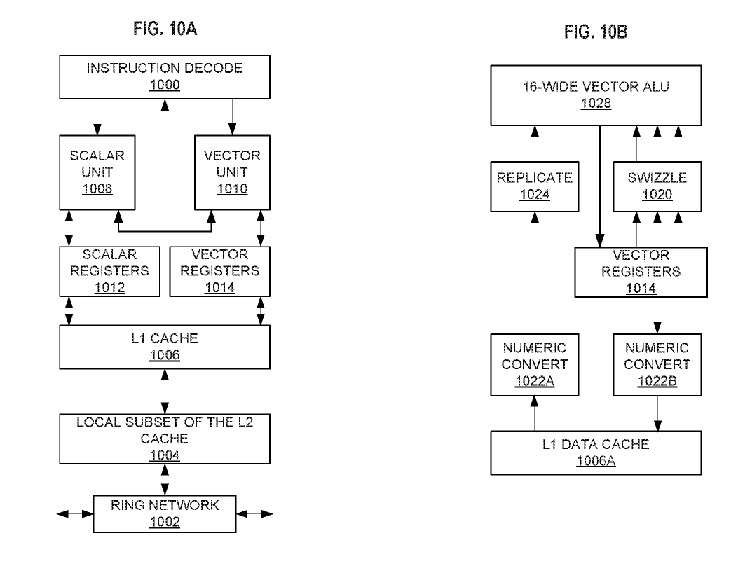

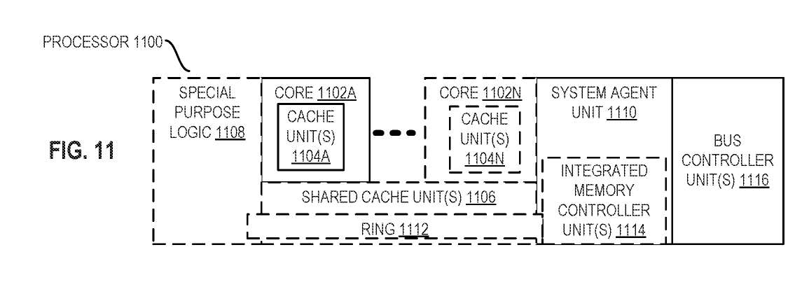

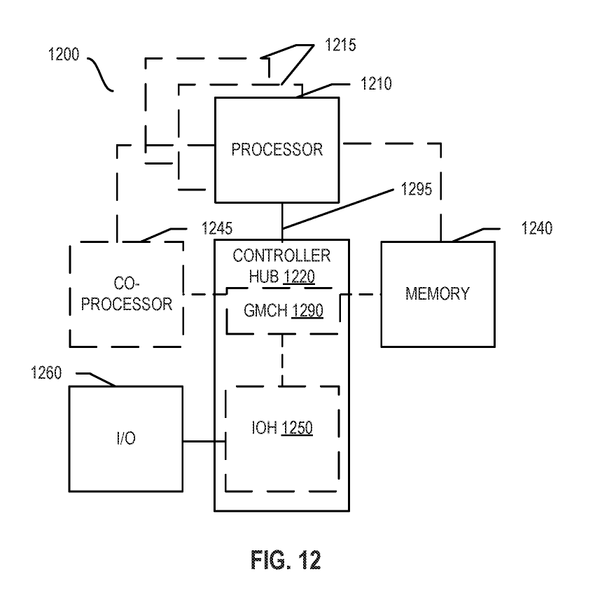

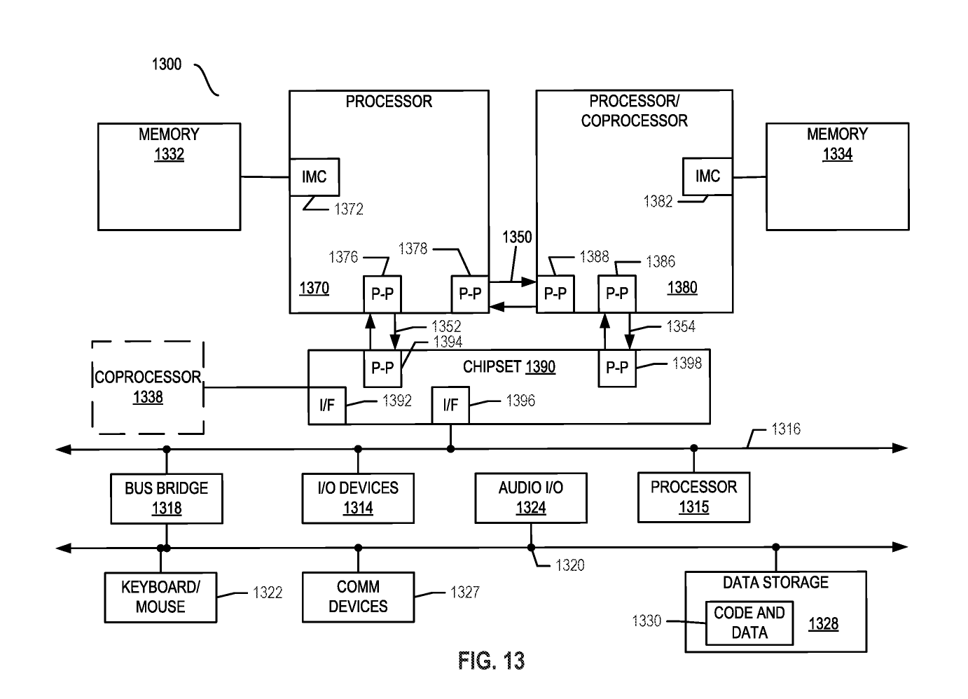

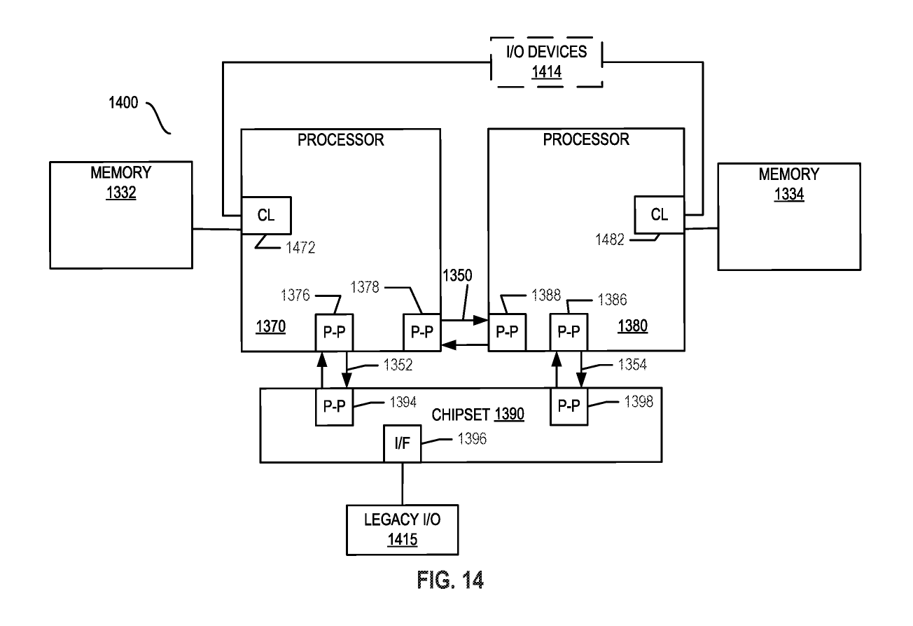

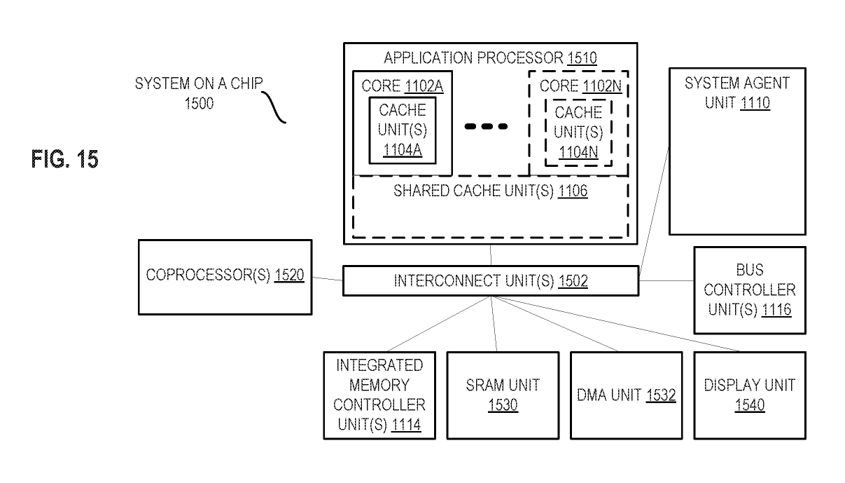

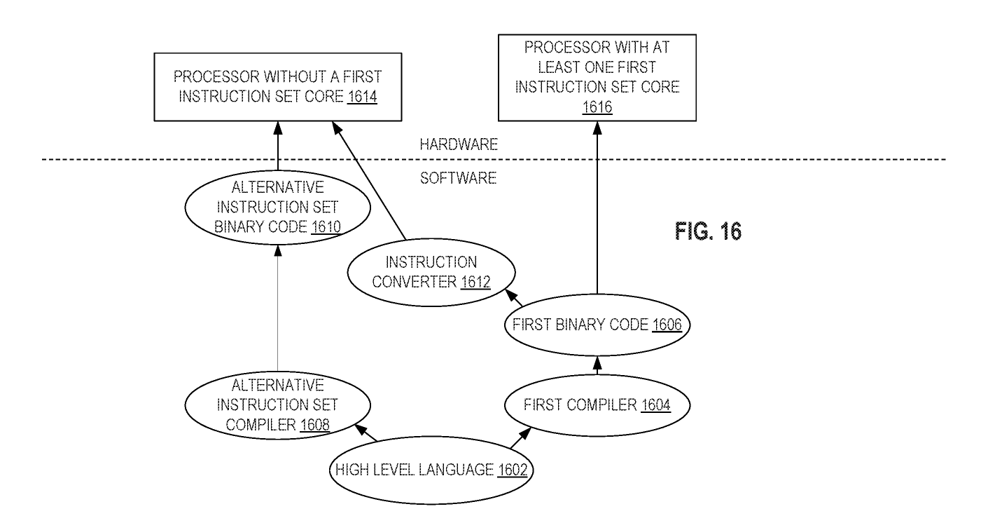

Some embodiments of the execution circuitry and processor pipeline in disclosed embodiments are discussed further below with respect to FIGS. 9A-9B, 10A-B, and 11. Additional embodiments of systems to process a VPYTH* instruction is illustrated and further discussed below with respect to FIG. 12, FIG. 13, FIG. 14, FIG. 15, and FIG. 16.

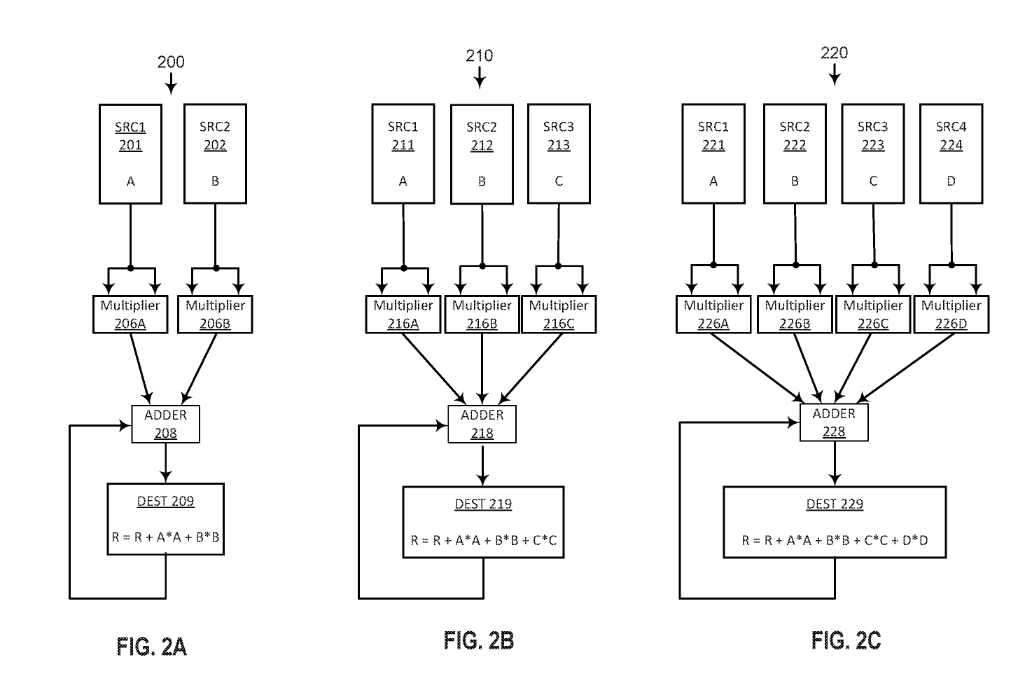

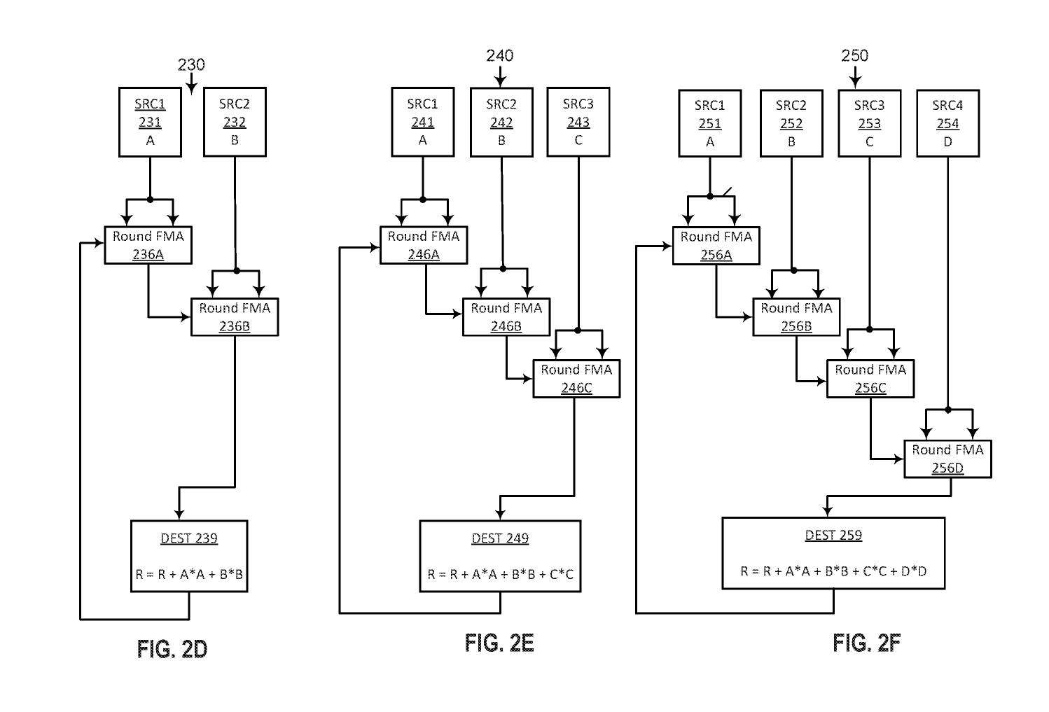

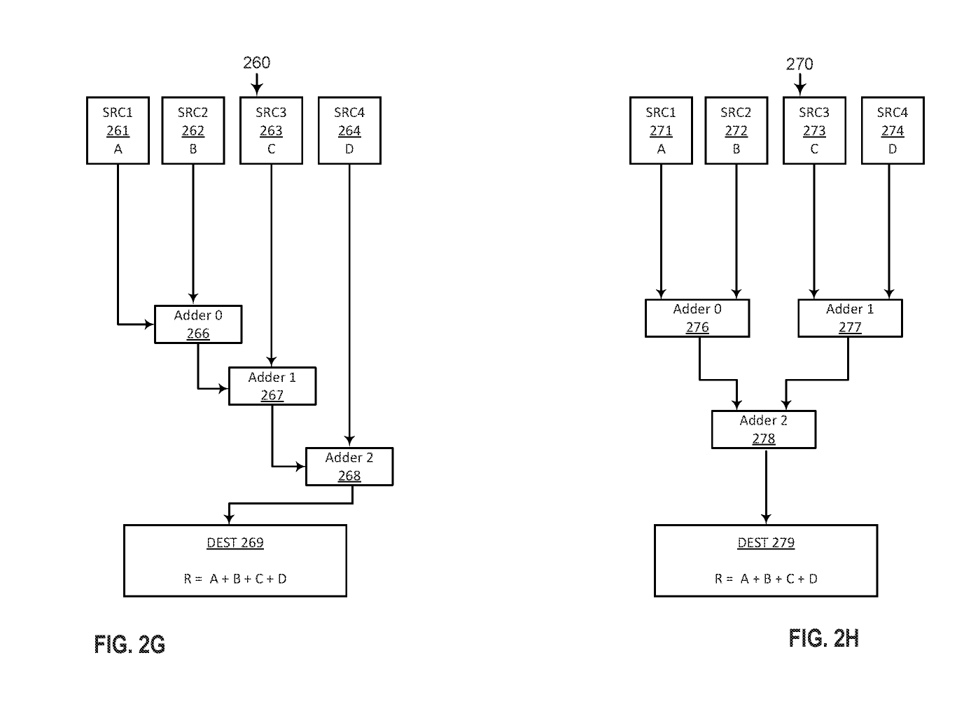

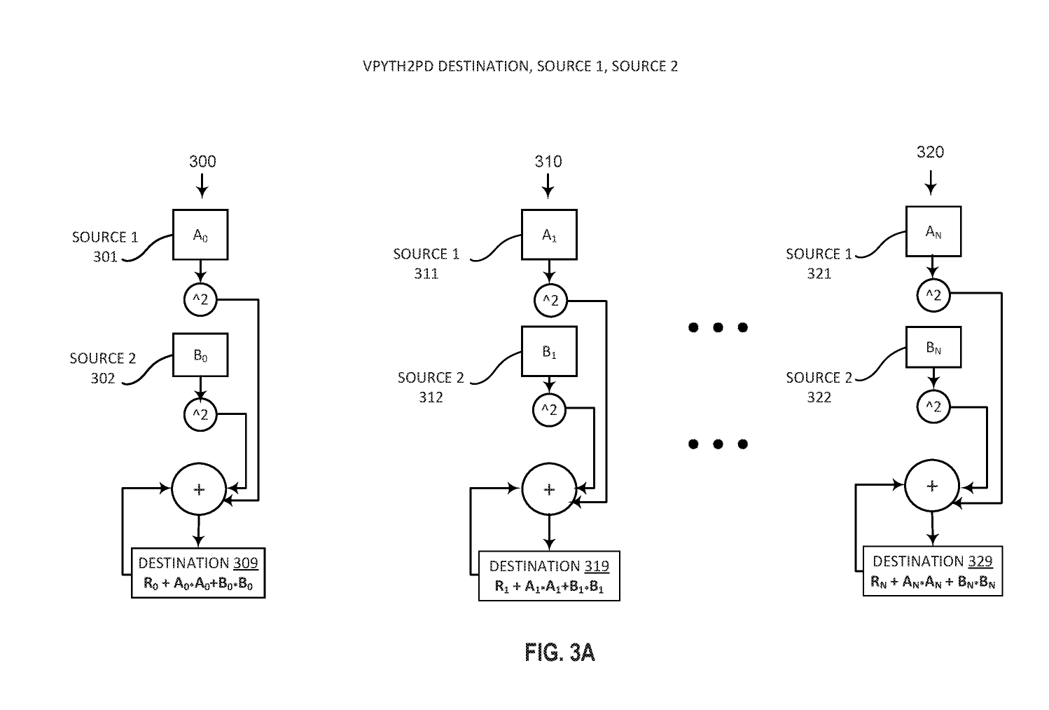

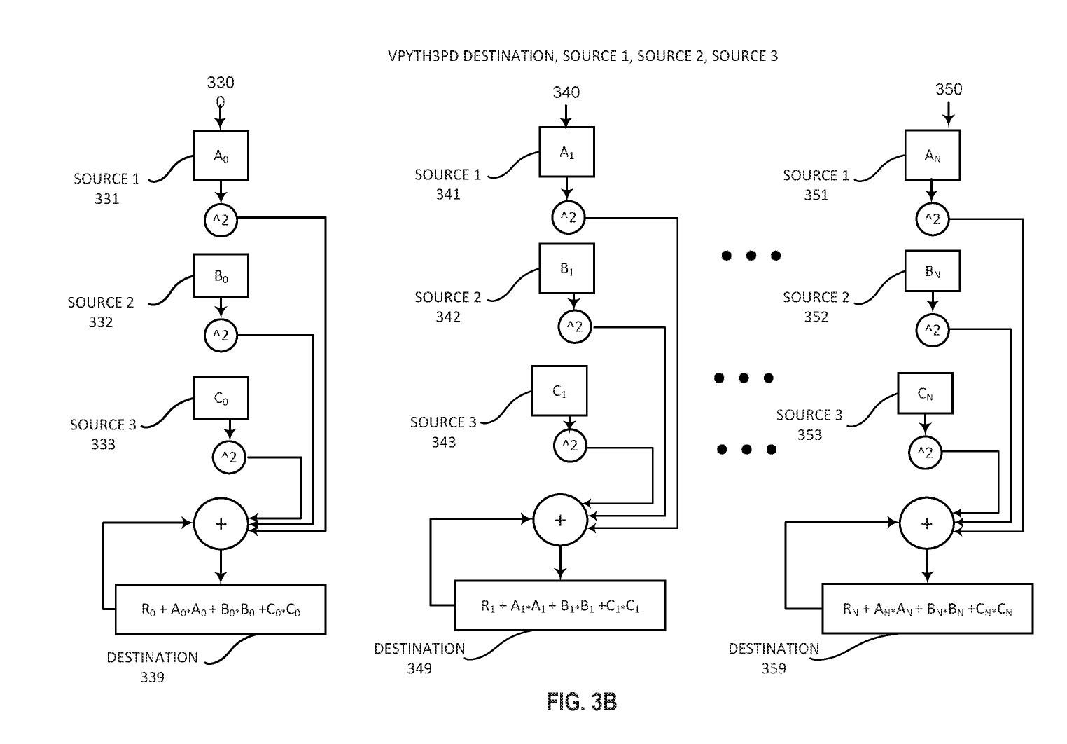

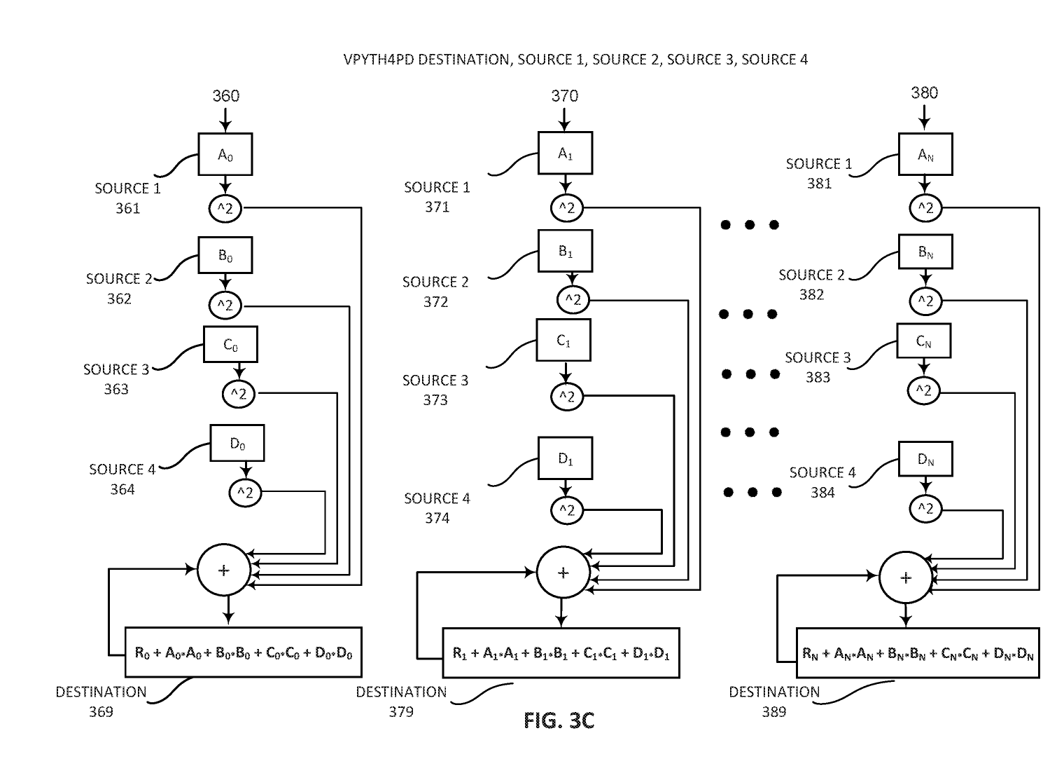

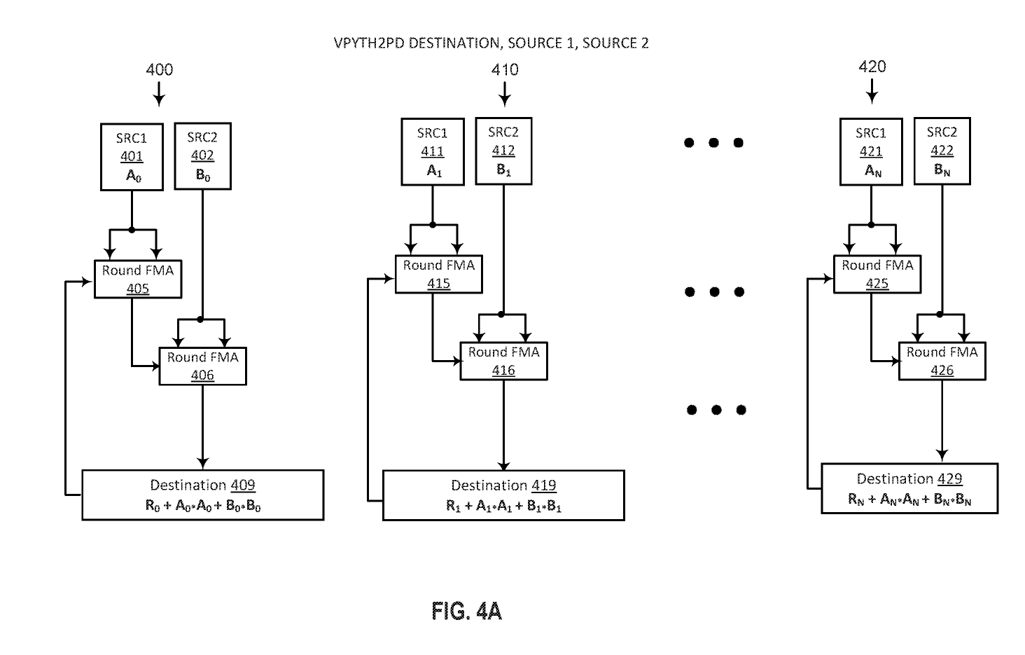

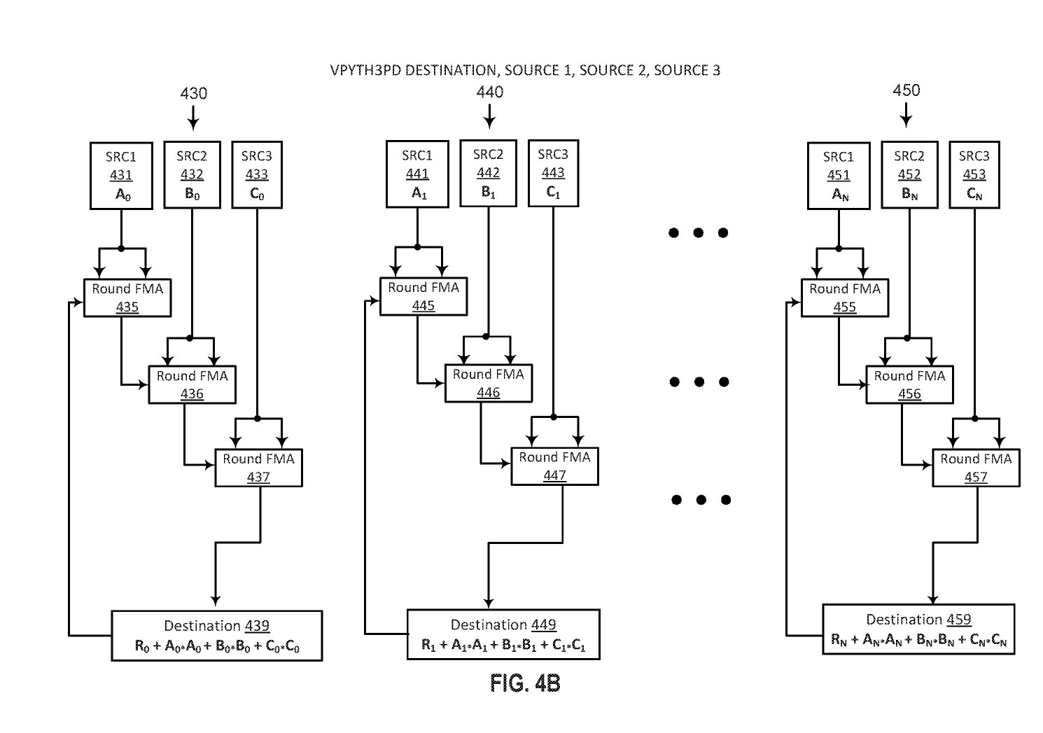

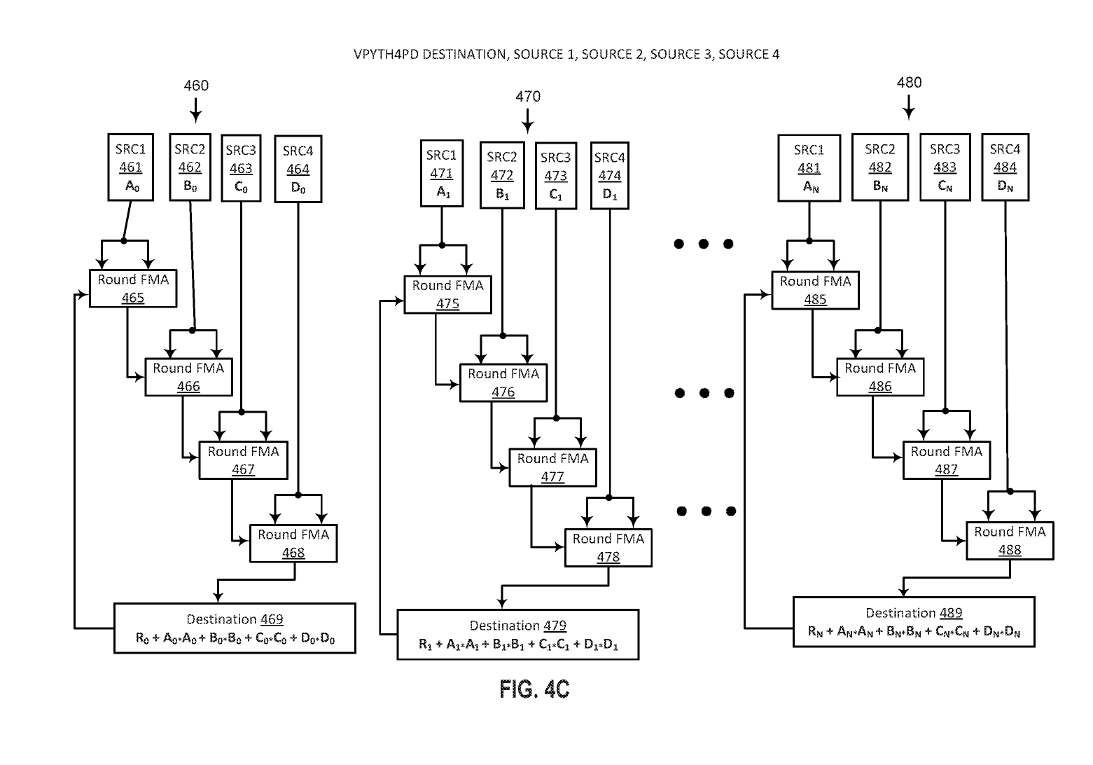

FIGS. 2A-2C are block diagrams illustrating execution of a scalar Pythagorean tuple instruction, according to some embodiments. The illustrated scalar execution circuits are also to be used to execute vectorized Pythagorean tuple instructions, by replicating the circuit for each of the vector elements. Execution of vectorized Pythagorean tuple instructions is described further below with respect to FIGS. 3A-4C.

FIG. 2A is a block diagram illustrating execution of a scalar order-2 Pythagorean tuple instruction, according to an embodiment. Circuit 200 executes a subset of a vectorized Pythagorean tuple instruction, insofar as it can be used to execute each of the packed data elements of the source vectors. When used to execute a subset of a vectorized Pythagorean tuple instruction, first and second sources 201 and 202 can be fixed-point integer values or floating point values packed into elements of vector registers, or packed into elements of a vector stored in memory. Circuit 200 can also be used by itself, operating on scalar input sources stored as elements of a vector register or in memory.

As shown, multiplier 206A generates a first product by multiplying the first source, SRC1 201, by itself (sometimes referred to herein as “squaring”), and multiplier 206B generates a second product by multiplying the second source, SRC2 202, by itself (a.k.a. squaring). Adder 208 accumulates the first product and the second product with the previous contents of destination 209. The resulting sum is stored in destination 209 and represents Pythagorean tuple. R+A*A+B*B.

Circuit 200 can be replicated N times to execute a vectorized order-2 Pythagorean tuple instruction in parallel on N elements of a packed data vector. Some embodiments reduce the amount of hardware required by executing the vectorized Pythagorean tuple instruction over multiple cycle. For example, the instruction can be executed over 2 cycles, reducing the required hardware by about a half, or over 4 cycles, reducing the number of instances of circuit 200 by about a quarter. In some embodiments, destination 209 is zeroed after reset so that it has an initial value.

In some embodiments, adder 208 performs saturation, if needed, at the end of the addition. In some embodiments, the data from the first and/or second sources is sign extended prior to multiplication. In some embodiments of integer versions of the instruction, saturation circuitry is used to preserve a sign of an operand when the addition results in a value that is too big. In particular, the saturation evaluation occurs on the infinite precision result in between the multi-way-add and the write to the destination. There are instances where the largest positive or least negative number cannot be trusted since it may reflect that a calculation exceeded the container space. However, this can at least be checked. In some embodiments, the sum of products and the floating point accumulator are turned into infinite precision values (fixed point numbers of hundreds of bits), the addition is performed, and then a single rounding to the actual accumulator type is performed.

In some embodiments, when the input terms are floating point operands, rounding and dealing with special values (infinities and not a numbers (NANs)), the ordering of faults in the calculation needs solving in the definition. In some embodiments, an order of operations is specified that is emulated and ensures that the implementation delivers faults in that order. It may be impossible for such an implementation to avoid multiple roundings in the course of the calculation. A single precision multiply can fill completely into a double precision result regardless of input values. However, the horizontal add of two such operations may not fit into a double without rounding, and the sum may not fit the accumulator without an additional rounding. In some embodiments, rounding is performed during the horizontal summation and once during the accumulation.

FIG. 2B is a block diagram illustrating execution of a scalar order-3 Pythagorean tuple instruction, according to an embodiment. Circuit 210 executes a subset of a vectorized Pythagorean tuple instruction, insofar as it can be used to execute each of the packed data elements of the source vectors. When used to execute a subset of a vectorized Pythagorean tuple instruction, first, second, and third sources 211, 212, and 213 can be fixed-point integer values or floating point values packed into elements of vector registers, or packed into elements of a vector stored in memory. Circuit 210 can also be used by itself, operating on scalar input sources stored as elements of a vector register, or in memory.

As shown, multiplier 216A generates a first product by multiplying the first source, SRC1 211, by itself (a.k.a. squaring), multiplier 216B generates a second product by multiplying the second source, SRC2 212, by itself (a.k.a. squaring), and multiplier 216C generates a third product by multiplying the third source, SRC3 213, by itself (a.k.a. squaring). Adder 218 accumulates the first, second, and third products with the previous contents of destination 219. FIGS. 2G and 2H, described further below, illustrate implementation of a 4-way adder, according to some embodiment. The resulting sum is stored in destination 219 and represents Pythagorean tuple. R+A*A+B*B+C*C.

Circuit 210 can be replicated N times to execute a vectorized order-3 Pythagorean tuple instruction in parallel on N elements of a packed data vector. Some embodiments reduce the amount of hardware required by executing the vectorized Pythagorean tuple instruction over multiple cycle. For example, the instruction can be executed over 2 cycles, reducing the required hardware by about a half, or over 4 cycles, reducing the number of instances of circuit 210 by about a quarter. In some embodiments, destination 219 is zeroed after reset.

FIG. 2C is a block diagram illustrating execution of a scalar order-4 Pythagorean tuple instruction, according to an embodiment. Circuit 220 executes a subset of a vectorized Pythagorean tuple instruction, insofar as it can be used to execute each of the packed data elements of the source vectors. When used to execute a subset of a vectorized Pythagorean tuple instruction, first, second, third, and fourth sources 221, 222, 223, and 224 can be fixed-point integer values or floating point values packed into elements of vector registers, or packed into elements of a vector stored in memory. Circuit 220 can also be used by itself, operating on scalar input sources stored as elements of a vector register or in memory.

As shown, multiplier 226A generates a first product by multiplying the first source, SRC1 221, by itself (a.k.a. squaring), multiplier 226B generates a second product by multiplying the second source, SRC2 222, by itself (a.k.a. squaring), multiplier 226C generates a third product by multiplying the third source, SRC3 223, by itself (a.k.a. squaring), and multiplier 226D generates a fourth product by multiplying the fourth source, SRC4 224, by itself (a.k.a. squaring). Adder 228 accumulates the first, second, third, and fourth products with the previous contents of destination 229. FIGS. 2G and 2H, described further below, illustrate implementation of a 4-way adder, according to some embodiment. The resulting sum is stored in destination 229 and represents Pythagorean tuple. R+A*A+B*B+C*C+D*D.

Circuit 220 can be replicated N times to execute a vectorized order-4 Pythagorean tuple instruction in parallel on N elements of a packed data vector. Some embodiments reduce the amount of hardware required by executing the vectorized Pythagorean tuple instruction over multiple cycle. For example, the instruction can be executed over 2 cycles, reducing the required hardware by about a half, or over 4 cycles, reducing the number of instances of circuit 220 by about a quarter. In some embodiments, destination 229 is zeroed after reset.

FIG. 2D is a block diagram illustrating execution of a scalar order-2 Pythagorean tuple instruction, according to an embodiment. Circuit 230 executes a subset of a vectorized Pythagorean tuple instruction, insofar as it can be used to execute each of the packed data elements of the source vectors. When used to execute a subset of a vectorized Pythagorean tuple instruction, first and second sources 231 and 232 can be fixed-point integer values or floating point values packed into elements of vector registers, or packed into elements of a vector stored in memory. Circuit 230 can also be used by itself, operating on scalar input sources stored as elements of a vector register or in memory.

Circuit 230 includes round FMA 236A and round FMA 236B, each of which performs a fused multiply and add, with rounding. In some embodiments, round FMA 236A and round FMA 236B comply with one or more standards promulgated by the Institute of Electrical and Electronic Engineers (IEEE), such as IEEE-754-2008. As shown, round FMA 236A generates a first product by multiplying the first source, SRC1 231, by itself (sometimes referred to herein as “squaring”), and accumulates the resulting product with the previous contents of DEST 239. In turn, round FMA 236B generates a second product by multiplying the second source, SRC2 232, by itself (a.k.a. squaring), and accumulating the product with the output of round FMA 236A. The resulting sum is stored in destination 239 and represents Pythagorean tuple. R+A*A+B*B.

Note that circuit 230 produces the same result as circuit 200 of FIG. 2A, but may result in different performance and cost considerations. Circuit 200 performs multiple multiplications independently, then adds the products with a 2-way adder. Circuit 230, in contrast, implements a chain of 2-way FMAs. Either circuit 200 or circuit 230 may be used to execute a VPYTH2P instruction, depending on cost and performance considerations.

Circuit 230 can be replicated N times to execute a vectorized order-2 Pythagorean tuple instruction in parallel on N elements of a packed data vector. Some embodiments reduce the amount of hardware required by executing the vectorized Pythagorean tuple instruction over multiple cycle. For example, the instruction can be executed over 2 cycles, reducing the required hardware by about a half, or over 4 cycles, reducing the number of instances of circuit 230 by about a quarter. In some embodiments, destination 239 is zeroed after reset so that it has an initial value.

FIG. 2E is a block diagram illustrating execution of a scalar order-3 Pythagorean tuple instruction, according to an embodiment. Circuit 240 executes a subset of a vectorized Pythagorean tuple instruction, insofar as it can be used to execute each of the packed data elements of the source vectors. When used to execute a subset of a vectorized Pythagorean tuple instruction, first, second, and third sources 241, 242, and 243 can be fixed-point integer values or floating point values packed into elements of vector registers, or packed into elements of a vector stored in memory. Circuit 240 can also be used by itself, operating on scalar input sources stored as elements of a vector register or in memory.

Circuit 240 includes round FMA 246A, round FMA 246B, and round FMA 246C, each of which performs a fused multiply and add, with rounding. In some embodiments, round FMA 246A, round FMA 246B, and round FMA 246C comply with one or more IEEE standards, such as IEEE-754-2008. As shown, round FMA 246A generates a first product by multiplying the first source, SRC1 241, by itself (sometimes referred to herein as “squaring”), and accumulates the resulting product with the previous contents of DEST 249. In turn, round FMA 246B generates a second product by multiplying the second source, SRC2 242, by itself (a.k.a. squaring), and accumulating the product with the output of round FMA 246A. In turn, round FMA 246C generates a third product by multiplying the third source, SRC3 243, by itself (a.k.a. squaring), and accumulating the product with the output of round FMA 246B. The resulting sum is stored in destination 249 and represents Pythagorean tuple. R+A*A+B*B+C*C.

Note that circuit 240 produces the same result as circuit 210 of FIG. 2B, but may result in different performance and cost considerations. Circuit 210 performs multiple multiplications independently, then adds the products with a 2-way adder. Circuit 240, in contrast, implements a chain of 2-way FMAs. Either circuit 220 or circuit 240 may be used to execute a VPYTH3P instruction, depending on cost and performance considerations.

Circuit 240 can be replicated N times to execute a vectorized order-3 Pythagorean tuple instruction in parallel on N elements of a packed data vector. Some embodiments reduce the amount of hardware required by executing the vectorized Pythagorean tuple instruction over multiple cycle. For example, the instruction can be executed over 2 cycles, reducing the required hardware by about a half, or over 4 cycles, reducing the number of instances of circuit 240 by about a quarter. In some embodiments, destination 249 is zeroed after reset so that it has an initial value.

FIG. 2F is a block diagram illustrating a circuit to execute a 4-way addition, according to an embodiment. Circuit 250 executes a subset of a vectorized Pythagorean tuple instruction, insofar as it can be used to execute each of the packed data elements of the source vectors. When used to execute a subset of a vectorized Pythagorean tuple instruction, first, second, third, and fourth sources 251, 252, 253, and 254 can be fixed-point integer values or floating point values packed into elements of vector registers, or packed into elements of a vector stored in memory. Circuit 250 can also be used by itself, operating on scalar input sources stored as elements of a vector register or in memory.

Circuit 250 includes round FMA 256A, round FMA 256B, round FMA 256C, and round FMA 256D, each of which performs a fused multiply and add, with rounding. In some embodiments, round FMA 256A, round FMA 256B, round FMA 256C, and round FMA 256D comply with one or more IEEE standards, such as IEEE-754-2008. As shown, round FMA 256A generates a first product by multiplying the first source, SRC1 251, by itself (sometimes referred to herein as “squaring”), and accumulates the resulting product with the previous contents of DEST 259. In turn, round FMA 256B generates a second product by multiplying the second source, SRC2 252, by itself (a.k.a. squaring), and accumulating the product with the output of round FMA 256A. In turn, round FMA 256C generates a third product by multiplying the third source, SRC3 253, by itself (a.k.a. squaring), and accumulating the product with the output of round FMA 256B. In turn, round FMA 256D generates a fourth product by multiplying the fourth source, SRC4 254, by itself (a.k.a. squaring), and accumulating the product with the output of round FMA 256C. The resulting sum is stored in destination 259 and represents Pythagorean tuple. R+A*A+B*B+C*C+D*D.

Note that circuit 250 produces the same result as circuit 220 of FIG. 2C, but may result in different performance and cost considerations. Circuit 220 performs multiple multiplications independently, then adds the products with a 4-way adder. Circuit 250, in contrast, implements a chain of 2-way FMAs. Either circuit 220 or circuit 250 may be used to execute a VPYTH3P instruction, depending on cost and performance considerations.

Circuit 250 can be replicated N times to execute a vectorized order-4 Pythagorean tuple instruction in parallel on N elements of a packed data vector. Some embodiments reduce the amount of hardware required by executing the vectorized Pythagorean tuple instruction over multiple cycle. For example, the instruction can be executed over 2 cycles, reducing the required hardware by about a half, or over 4 cycles, reducing the number of instances of circuit 250 by about a quarter. In some embodiments, destination 259 is zeroed after reset so that it has an initial value.

FIG. 2G is a block diagram illustrating a circuit to execute a 4-way addition, according to an embodiment. As shown, circuit 260 implements a chain adder: the four sources, SRC1 261, SRC2 262, SRC3 263, and SRC4 264 are added to each other using a chain of three adders: Adder 0 266 adds the first and second sources, SRC1 261 and SRC2 262. Adder 1 267 adds the result of adder 0 266 to the third source, SRC3 263. Adder 2 268 adds the result of adder 1 267 to the fourth source, SRC4 264. The result, representing A+B+C+D, is stored in destination 269.

FIG. 2H is a block diagram illustrating a circuit to execute a 4-way addition, according to an embodiment. As shown, circuit 270 implements a tree adder: the four sources, SRC1 271, SRC2 272, SRC3 273, and SRC4 274 are added to each other using a tree of three adders: Adder 0 276 adds the first and second sources, SRC1 271 and SRC2 272. In parallel and independently, adder 1 277 adds the third and fourth sources, SRC3 273 and SRC4 274. Adder 2 278 adds the results of adder 0 276 and adder 1 277. The result, representing A+B+C+D, is stored in destination 279.

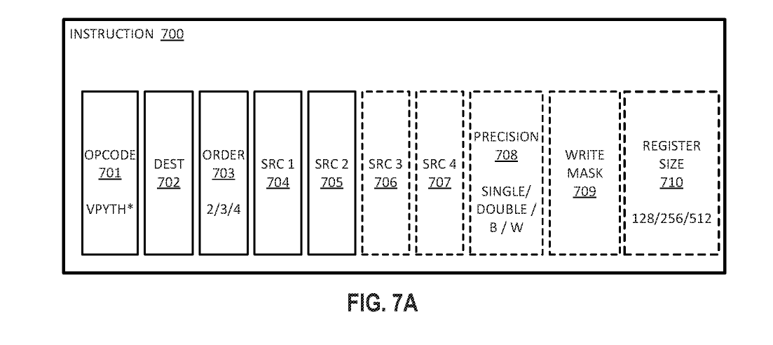

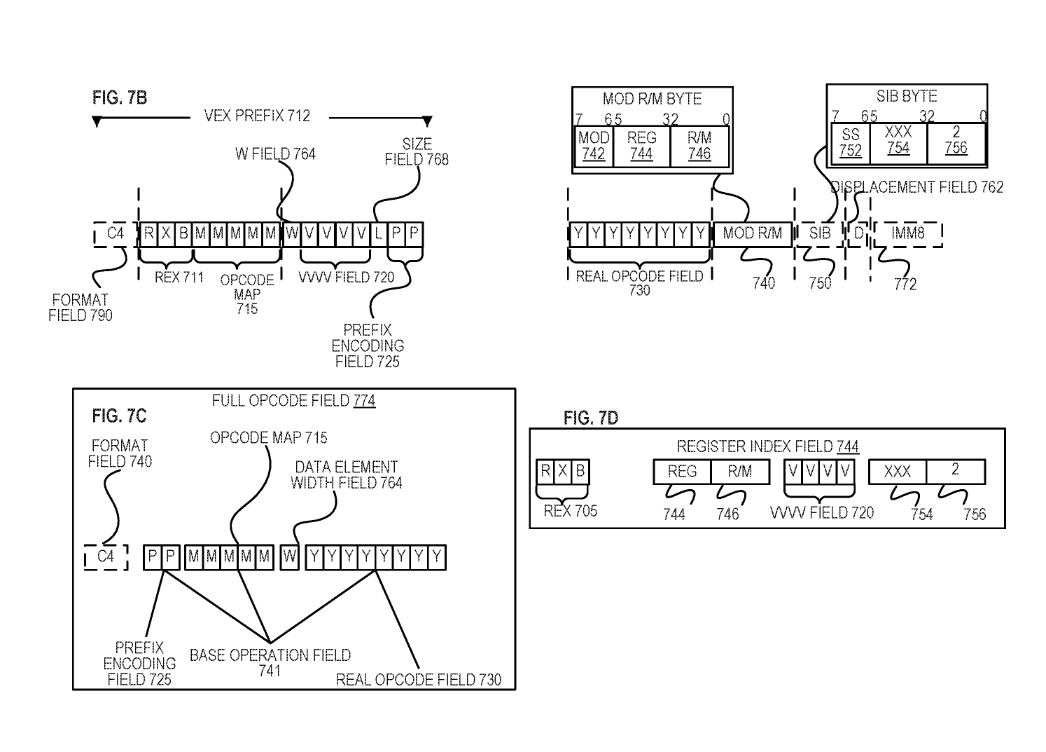

FIG. 3A is a block diagram illustrating an execution circuit for executing vectorized order-2 Pythagorean tuples instructions, according to some embodiments. The execution circuit is to execute a VPYTH2PD (indicating a Vector Pythagorean order-2 packed double-precision vector instruction) instruction, which further includes a destination identifier, DESTINATION, a first source identifier, SOURCE 1, and a second source identifier, SOURCE 2, as inputs. Here, the Pythagorean order, 2, is specified as part of the opcode, but in other embodiments, the order can be specified by an additional instruction operand. Here, the elements to be processed are doublewords (64 bits), as specified by the “D” in the opcode, but in other embodiments the precision of the elements is specified by an additional instruction operand. In some embodiments, the instruction further includes a writemask, which is a multi-bit value that conditions writing of the destination register on a per-element basis. Here, the size of the source and destination vector registers, and thus the number of elements to process, N, has a default value of 256 (so N=8), but some other embodiments specify the vector size with an additional instruction operand. The various formats for the vector Pythagorean tuple instructions are described further below with respect to FIGS. 7A-7D.

As shown, each element of the destination register is generated by a circuit including two multipliers and an accumulator. In particular, the least significant element, R₀, of DESTINATION 309 is generated by generating a first product by multiplying the least significant element A₀ of SOURCE 1 301 by itself, generating a second product by multiplying the least significant element B₀ of SOURCE 2 392 by itself, and accumulating the first product and the second product with the previous value of R₀. The second least significant element, R₁, of DESTINATION 319 is generated by generating a first product by multiplying the second least significant element A₁ of SOURCE 1 311 by itself, generating a second product by multiplying the second least significant element B₁ of SOURCE 2 312 by itself, and accumulating the first product and the second product with the previous value of R₁. The most significant element, R_{N}, of DESTINATION 329 is generated by generating a first product by multiplying the most significant element A_{N} of SOURCE 1 321 by itself, generating a second product by multiplying the most significant element B_{N} of SOURCE 2 322 by itself, and accumulating the first product and the second product with the previous value of R.

Each remaining element of the destination register is generated in a similar fashion. In some embodiments, the execution circuit generates each element of the destination register in parallel. In some embodiments, about half as much hardware is used by taking two cycles to update the destination register. In some embodiments, a quarter as much hardware is used by taking four cycles to update the destination register. In some embodiments, each of the elements of the destination register is updated in serial.

It should be noted that FIG. 3A shows the destination and source vector registers in big endian format, with the least significant element on the left. In other embodiments, little endian encoding is used.

FIG. 3B is a block diagram illustrating an execution circuit for executing vectorized order-3 Pythagorean tuples instructions, according to some embodiments. The execution circuit is to execute instruction a VPYTH3PD (indicating a Vector Pythagorean order-3 packed double-precision vector instruction) instruction, which includes a destination identifier, DESTINATION, a first source identifier, SOURCE 1, a second source identifier SOURCE 2, and a third source identifier, SOURCE 3, as inputs.

As shown, each element of the destination register is generated by a circuit including three multipliers and an accumulator. In particular, the least significant element, R₀, of DESTINATION 339 is generated by generating a first product by multiplying the least significant element A₀ of SOURCE 1 331 by itself, generating a second product by multiplying the least significant element B₀ of SOURCE 2 332 by itself, generating a third product by multiplying the least significant element C₀ of SOURCE 3 333 by itself, and accumulating the first, second, and third products with the previous value of R₀. The second least significant element, R₁, of DESTINATION 349 is generated by generating a first product by multiplying the second least significant element A₁ of SOURCE 1 341 by itself, generating a second product by multiplying the second least significant element B₁ of SOURCE 2 342 by itself, generating a third product by multiplying the second least significant element C₁ of SOURCE 3 343 by itself, and accumulating the first, second, and third products with the previous value of R₁. The most significant element, R_{N}, of DESTINATION 359 is generated by generating a first product by multiplying the most significant element A_{N} of SOURCE 1 351 by itself, generating a second product by multiplying the most significant element B_{N} of SOURCE 2 352 by itself, generating a third product by multiplying the most significant element C_{N} of SOURCE 3 353 by itself, and accumulating the first, second, and third products with the previous value of R_{N}.

Each remaining element of the destination register is generated in a similar fashion. In some embodiments, the execution circuit generates each element of the destination register in parallel. In some embodiments, about half as much hardware is used by taking two cycles to update the destination register. In some embodiments, a quarter as much hardware is used by taking four cycles to update the destination register. In some embodiments, each of the elements of the destination register is updated in serial.

FIG. 3C is a block diagram illustrating an execution circuit for executing vectorized order-4 Pythagorean tuples instructions, according to some embodiments. FIG. 3C is a block diagram illustrating an execution circuit for executing vectorized order-4 Pythagorean tuples instructions, according to some embodiments. The execution circuit is to execute a VPYTH4PD (indicating a Vector Pythagorean order-4 packed double-precision vector instruction), which includes a destination identifier, DESTINATION, a first source identifier, SOURCE 1, a second source identifier, SOURCE 2, a third source identifier, SOURCE 3, and a fourth source identifier, SOURCE 4, as inputs.

As shown, each element of the destination register is generated by a circuit including four multipliers and an accumulator. In particular, the least significant element, R₀, of DESTINATION 369 is generated by generating a first product by multiplying the least significant element A₀ of SOURCE 1 361 by itself, generating a second product by multiplying the least significant element B₀ of SOURCE 2 362 by itself, generating a third product by multiplying the least significant element C₀ of SOURCE 3 363 by itself, generating a fourth product by multiplying the least significant element D₀ of SOURCE 4 364 by itself, and accumulating the first, second, third, and fourth products with the previous value of R₀. The second least significant element, R₁, of DESTINATION 379 is generated by generating a first product by multiplying the second least significant element A₁ of SOURCE 1 371 by itself, generating a second product by multiplying the second least significant element B₁ of SOURCE 2 372 by itself, generating a third product by multiplying the second least significant element C₁ of SOURCE 3 373 by itself, generating a fourth product by multiplying the second least significant element D₁ of SOURCE 4 374 by itself, and accumulating the first, second, third, and fourth third products with the previous value of R₁. The most significant element, R_{N}, of DESTINATION 389 is generated by generating a first product by multiplying the most significant element A_{N} of SOURCE 1 381 by itself, generating a second product by multiplying the most significant element B_{N} of SOURCE 2 382 by itself, generating a third product by multiplying the most significant element C_{N} of SOURCE 3 383 by itself, generating a fourth product by multiplying the most significant element D_{N} of SOURCE 4 384 by itself, and accumulating the first, second, third, and fourth products with the previous value of R_{N}.

Each remaining element of the destination register is generated in a similar fashion. In some embodiments, the execution circuit generates each element of the destination register in parallel. In some embodiments, about half as much hardware is used by taking two cycles to update the destination register. In some embodiments, a quarter as much hardware is used by taking four cycles to update the destination register. In some embodiments, each of the elements of the destination register is updated in serial.

FIG. 4A is a block diagram illustrating processing components for executing vectorized order-2 Pythagorean tuple instructions, according to some embodiments. The execution circuit is to execute a VPYTH2PD (indicating a Vector Pythagorean order-2 packed double-precision vector instruction) instruction, which includes a destination identifier, DESTINATION, a first source identifier, SOURCE 1, and a second source identifier, SOURCE 2, as inputs.

As shown, each element of the destination register is generated by a circuit including two round FMA instances. In particular, the least significant element, R₀, of DESTINATION 409 is generated by using round FMA 405 to generate a first product by multiplying the least significant element A₀ of SOURCE 1 401 by itself and accumulating the result with previous contents of destination 409, using round FMA 406 to generate a second product by multiplying the least significant element B₀ of SOURCE 2 402 by itself, and accumulating the result with the result of round FMA 405. The result is written to DESTINATION 409 and represents R₀+A₀*A₀+B₀*B₀.

The next least significant element, R₁, of DESTINATION 419 is generated by using round FMA 415 to generate a first product by multiplying the next least significant element A₁ of SOURCE 1 411 by itself and accumulating the result with previous contents of destination 419, using round FMA 416 to generate a second product by multiplying the next least significant element B₁ of SOURCE 2 412 by itself, and accumulating the result with the result of round FMA 415. The result is written to DESTINATION 419 and represents R₁+A₁*A₁+B₁*B₁.

The most significant element, R_{N}, of DESTINATION 429 is generated by using round FMA 425 to generate a first product by multiplying the most significant element A_{N} of SOURCE 1 421 by itself and accumulating the result with previous contents of destination 429, using round FMA 426 to generate a second product by multiplying the most significant element B_{N} of SOURCE 2 422 by itself, and accumulating the result with the result of round FMA 425. The result is written to DESTINATION 429 and represents R_{N}+A_{N}*A_{N}B_{N}*B_{N}.

Each remaining element of the destination register is generated in a similar fashion. In some embodiments, the execution circuit generates each element of the destination register in parallel. In some embodiments, about half as much hardware is used by taking two cycles to update the destination register. In some embodiments, a quarter as much hardware is used by taking four cycles to update the destination register. In some embodiments, each of the elements of the destination register is updated in serial.

FIG. 4B is a block diagram illustrating processing components for executing vectorized order-3 Pythagorean tuple instructions, according to some embodiments. The execution circuit is to execute a VPYTH3PD (indicating a Vector Pythagorean order-3 packed double-precision vector instruction) instruction, which includes a destination identifier DESTINATION, a first source identifier, SOURCE 1, a second source identifier, SOURCE 2, and a third source identifier, SOURCE 3, as inputs.

As shown, each element of the destination register is generated by a circuit including three round FMA instances. In particular, the least significant element, R₀, of DESTINATION 439 is generated by using round FMA 435 to generate a first product by multiplying the least significant element A₀ of SOURCE 1 431 by itself and accumulating the result with previous contests of destination 439, using round FMA 436 to generate a second product by multiplying the least significant element B₀ of SOURCE 2 432 by itself, and accumulating the result with the result of round FMA 435. using round FMA 437 to generate a third product by multiplying the least significant element C₀ of SOURCE 3 43 by itself, and accumulating the result with the result of round FMA 436. The result is written to DESTINATION 439 and represents R₀+A₀*A₀+B₀*B₀+C₀*C₀.

The next least significant element, R₁, of DESTINATION 449 is generated by using round FMA 445 to generate a first product by multiplying the next least significant element A₁ of SOURCE 1 441 by itself and accumulating the result with previous contents of destination 449, using round FMA 446 to generate a second product by multiplying the next least significant element B₁ of SOURCE 2 442 by itself, and accumulating the result with the result of round FMA 445, using round FMA 447 to generate a third product by multiplying the next least significant element C₁ of SOURCE 3 445 by itself, and accumulating the result with the result of round FMA 446. The result is written to DESTINATION 449 and represents R₁+A₁*A₁+B₁*B₁+C₁*C₁

The most significant element, R_{N}, of DESTINATION 459 is generated by using round FMA 455 to generate a first product by multiplying the most significant element A_{N} of SOURCE 1 451 by itself and accumulating the result with previous contents of destination 459, using round FMA 456 to generate a second product by multiplying the most significant element B_{N} of SOURCE 2 452 by itself, and accumulating the result with the result of round FMA 455, and using round FMA 457 to generate a third product by multiplying the most significant element C_{N} of SOURCE 3 453 by itself, and accumulating the result with the result of round FMA 456. The result is written to DESTINATION 459 and represents R_{N}+A_{N}*A_{N}+B_{N}*B_{N}+C_{N}*C_{N}.

Each remaining element of the destination register is generated in a similar fashion. In some embodiments, the execution circuit generates each element of the destination register in parallel. In some embodiments, about half as much hardware is used by taking two cycles to update the destination register. In some embodiments, a quarter as much hardware is used by taking four cycles to update the destination register. In some embodiments, each of the elements of the destination register is updated in serial.

FIG. 4C is a block diagram illustrating processing components for executing vectorized order-4 Pythagorean tuple instructions, according to some embodiments. The execution circuit is to execute a VPYTH3PD (indicating a Vector Pythagorean order-4 packed double-precision vector instruction) instruction, which includes a destination identifier DESTINATION, a first source identifier, SOURCE 1, a second source identifier, SOURCE 2, a third source identifier, SOURCE 3, and a fourth source identifier, SOURCE 4, as inputs.

As shown, each element of the destination register is generated by a circuit including four round FMA instances. In particular, the least significant element, R₀, of DESTINATION 469 is generated by using round FMA 465 to generate a first product by multiplying the least significant element A₀ of SOURCE 1 461 by itself and accumulating the result with previous contents of destination 469, using round FMA 466 to generate a second product by multiplying the least significant element B₀ of SOURCE 2 462 by itself, and accumulating the result with the result of round FMA 465. using round FMA 467 to generate a third product by multiplying the least significant element C₀ of SOURCE 3 463 by itself, using round FMA 468 to generate a fourth product by multiplying the least significant element D₀ of SOURCE 4 464 by itself and accumulating the result with the result of round FMA 467. The result is written to DESTINATION 469 and represents R₀+A₀*A₀+B₀*B₀+C₀*C₀+D₀*D₀.

The next least significant element, R₁, of DESTINATION 479 is generated by using round FMA 475 to generate a first product by multiplying the next least significant element Aₗ of SOURCE 1 471 by itself and accumulating the result with previous contents of destination 479, using round FMA 476 to generate a second product by multiplying the next least significant element B₁ of SOURCE 2 472 by itself, and accumulating the result with the result of round FMA 475, using round FMA 477 to generate a third product by multiplying the next least significant element C₁ of SOURCE 3 473 by itself, using round FMA 478 to generate a fourth product by multiplying the next least significant element D₁ of SOURCE 4 474 by itself, and accumulating the result with the result of round FMA 477. The result is written to DESTINATION 479 and represents R₁+A₁*A₁+B₁* B₁+C₁*C₁+D₁*D₁.

The most significant element, R_{N}, of DESTINATION 489 is generated by using round FMA 485 to generate a first product by multiplying the most significant element A_{N} of SOURCE 1 481 by itself and accumulating the result with previous contents of destination 489, using round FMA 486 to generate a second product by multiplying the most significant element B_{N} of SOURCE 2 482 by itself, and accumulating the result with the result of round FMA 485, using round FMA 487 to generate a third product by multiplying the most significant element C_{N} of SOURCE 3 483 by itself, and accumulating the result with the result of round FMA 486, and using round FMA 488 to generate a fourth product by multiplying the most significant element D_{N} of SOURC4 3 484 by itself, and accumulating the result with the result of round FMA 487. The result is written to DESTINATION 489 and represents R_{N}+A_{N}*A_{N}+B_{N}*B_{N}+C_{N}*C_{N}+D_{N}*D_{N}.

Each remaining element of the destination register is generated in a similar fashion. In some embodiments, the execution circuit generates each element of the destination register in parallel. In some embodiments, about half as much hardware is used by taking two cycles to update the destination register. In some embodiments, a quarter as much hardware is used by taking four cycles to update the destination register. In some embodiments, each of the elements of the destination register is updated in serial.

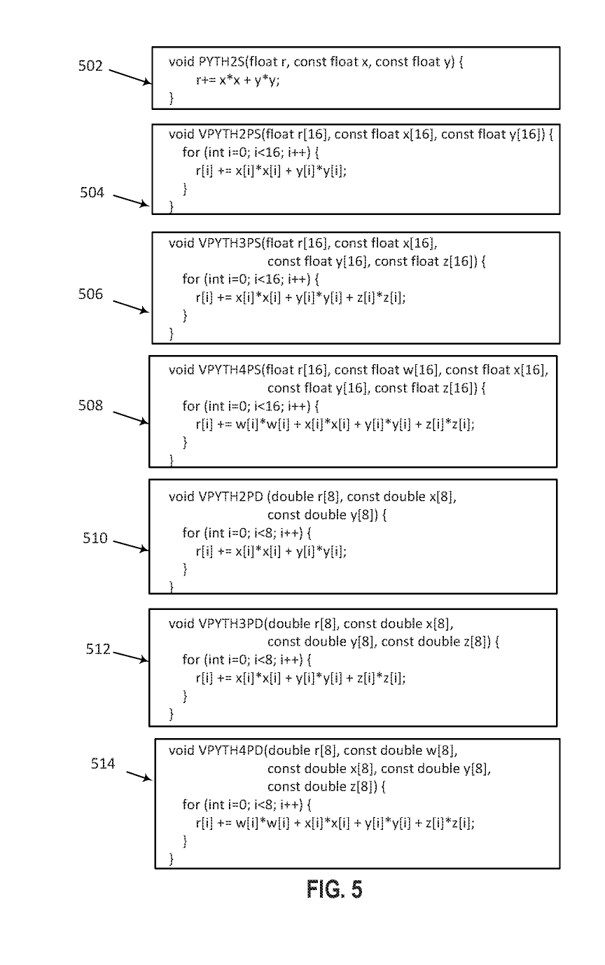

FIG. 5 illustrates pseudocode for executing vectorized Pythagorean tuples instructions, according to some embodiments. As shown, pseudocode 502 executes an order-2 Pythagorean tuple instruction having single-precision scalar inputs. Pseudocode 502 executes a subset of a vectorized Pythagorean tuple instruction, insofar as it describes the execution of each of the packed data elements of the vectors. Pseudocode 504, 506, and 508 execute single precision vector Pythagorean tuples instructions having order 2, order 3, and order 4, respectively. Pseudocode 510, 512, and 514 execute double precision vector Pythagorean tuples instructions having order 2, order 3, and order 4, respectively.

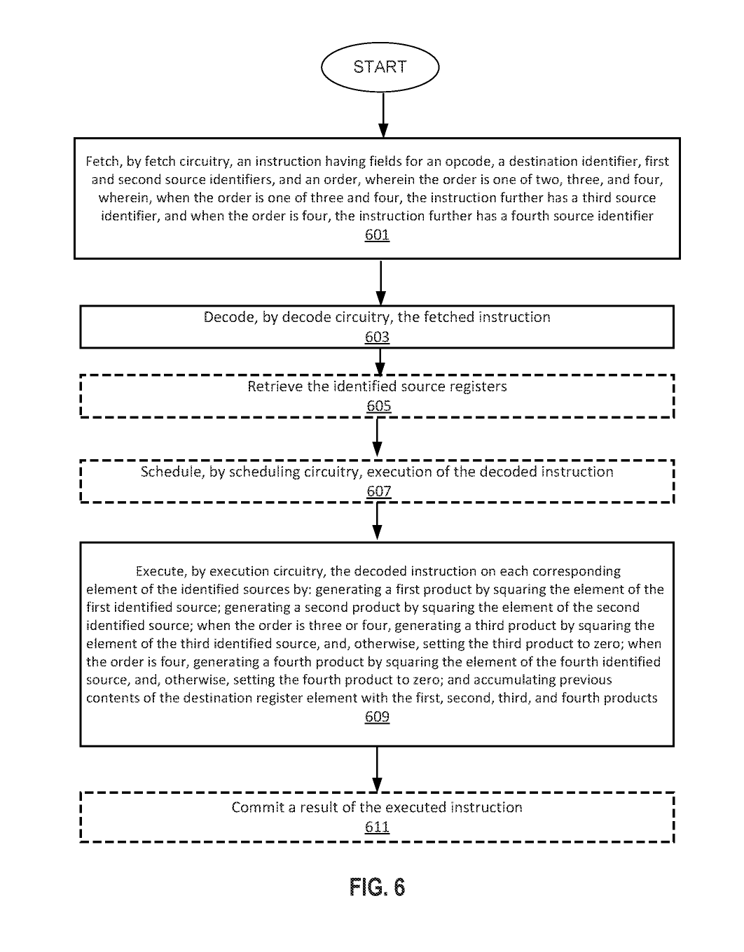

FIG. 6 is a block flow diagram of a process performed by a processor to execute a vectorized Pythagorean tuples instruction, according to some embodiments. In operation, after starting, at 601, fetch circuitry is to fetch an instruction having fields for an opcode, a destination identifier, first and second source identifiers, and an order, wherein the order is one of two, three, and four. At 603, the fetched instruction is decoded by decode circuitry. At 605, the identified sources are retrieved. 605 is optional, as indicated by its dashed border, insofar as retrieving the sources may occur in a different pipeline stage, at a different time, or not at all. The identified sources can be in vector registers or in memory. At 607, scheduling circuit schedules execution of the decoded instruction; 607 is optional, as indicated by its dashed border, insofar as scheduling execution may occur in a different pipeline stage, by different circuitry, at a different time, or not at all At 609, execution circuitry is to execute the decoded instruction on each corresponding element of the identified sources by: generating a first product by squaring the element of the first identified source, generating a second product by squaring the element of the second identified source, when the order is three or four, generating a third product by squaring the element of the third identified source, and, otherwise, setting the third product to zero, when the order is four, generating a fourth product by squaring the element of the fourth identified source, and, otherwise, setting the fourth product to zero; and accumulating previous contents of the destination register element with the first, second, third, and fourth products. At 611, execution results are committed. 611 is optional, as indicated by its dashed border, at least insofar as it could be executed at a different stage of the pipeline, at a different time, or not at all. The various formats for the vector Pythagorean tuple instructions are described further below with respect to FIGS. 7A-7D.

FIG. 7A is a block diagram illustrating a format for vectorized Pythagorean tuples instructions, according to some embodiments. As shown, instruction 600 includes opcode 701 (VPYTH*), destination identifier DEST 702, order 703, first source identifier SRC1 704, second source identifier SRC2 705, third source identifier SRC3 705, fourth source identifier SRC 4 707, precision 708, writemask 709, and register size 710. Dashed borders are used to indicate that third source identifier SRC3 706, fourth source identifier SRC 4 707, precision 708, writemask 709, and register size 710 are optional parameters.

Opcode 701 is illustrated with an exemplary opcode, VPYTH*, which includes an asterisk. The asterisk signifies that the opcode can include various prefixes or suffixes to specify the instruction behavior. For example, a “2,” “3,” or “4” can be included as a prefix to the opcode, the prefix taking the place of order operand 703.

Destination identifier DEST 702, and source identifiers SRC 1 704, SRC 2 705, SRC 3 706, and SRC 4 707 can specify a packed data vector register, or a memory location containing a packed data vector. The third and fourth sources, SRC 3 706 and SRC 4 707 are optional insofar as they are only included when the order 703 is three or four. Precision 708 specifies the size of each of the vector elements to be processed, and is one of SINGLE (32-bit single-precision floating point) and DOUBLE (64-bit double-precision floating point). Precision 708 can also specify 8-bit sized and 16-bit sized vector elements. Precision 708 is optional, as indicated by its dashed border, insofar as a default precision is used if the instruction lacks a precision operand. Writemask 709 is a multi-bit value, with each bit controlling whether execution results will be written to a corresponding element of the destination. Register size 710 specifies the width of the source and destination registers, and specifies one of 128 bits, 256 bits, and 512 bits. The register size, divided by the size of the elements, indicates how many elements will be processed.

The format of the VPYTH* instruction according to disclosed embodiments is further described below, and with reference to FIGS. 7B-7D.

Detailed below are further embodiments of an instruction format for the above described instructions and architectures (e.g., pipelines, cores, etc.) and systems that support these instructions and the embodiments detailed above.

### Instruction Set

An instruction set includes one or more instruction formats. A given instruction format defines various fields (number of bits, location of bits) to specify, among other things, the operation to be performed (opcode) and the operand(s) on which that operation is to be performed. Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### VEX Instruction Format

VEX encoding allows instructions to have more than two operands, and allows SIMD vector registers to be longer than 78 bits. The use of a VEX prefix provides for three-operand (or more) syntax. For example, previous two-operand instructions performed operations such as A=A+B, which overwrites a source operand. The use of a VEX prefix enables operands to perform nondestructive operations such as A=B+C.

FIG. 7B illustrates an exemplary AVX instruction format including a VEX prefix 712, real opcode field 730, Mod R/M byte 740, SIB byte 750, displacement field 762, and IMM8 772. FIG. 7C illustrates which fields from FIG. 7B make up a full opcode field 774 and a base operation field 741. FIG. 7D illustrates which fields from FIG. 7B make up a register index field 744.

VEX Prefix (Bytes 0-2) 712 is encoded in a three-byte form. The first byte is the Format Field 790 (VEX Byte 0, bits [7:0]), which contains an explicit C4 byte value (the unique value used for distinguishing the C4 instruction format). The second-third bytes (VEX Bytes 1-2) include a number of bit fields providing specific capability. Specifically, REX field 711 (VEX Byte 1, bits [7-5]) consists of a VEX.R bit field (VEX Byte 1, bit [7]-R), VEX.X bit field (VEX byte 1, bit [6]-X), and VEX.B bit field (VEX byte 1, bit [5]-B). Other fields of the instructions encode the lower three bits of the register indexes as is known in the art (rrr, xxx, and bbb), so that Rrrr, Xxxx, and Bbbb may be formed by adding VEX.R, VEX.X, and VEX.B. Opcode map field 715 (VEX byte 1, bits [4:0]-mmmmm) includes content to encode an implied leading opcode byte. W Field 764 (VEX byte 2, bit [7]-W)—is represented by the notation VEX.W, and provides different functions depending on the instruction. The role of VEX.vvvv 720 (VEX Byte 2, bits [6:3]-vvvv) may include the following: 1) VEX.vvvv encodes the first source register operand, specified in inverted (1s complement) form and is valid for instructions with 2 or more source operands; 2) VEX.vvvv encodes the destination register operand, specified in 1s complement form for certain vector shifts; or 3) VEX.vvvv does not encode any operand, the field is reserved and should contain 1111b. If VEX.L 768 Size field (VEX byte 2, bit [2]-L) =0, it indicates 78 bit vector; if VEX.L =1, it indicates 256 bit vector. Prefix encoding field 725 (VEX byte 2, bits [1:0]-pp) provides additional bits for the base operation field 741.

Real Opcode Field 730 (Byte 3) is also known as the opcode byte. Part of the opcode is specified in this field.

MOD R/M Field 740 (Byte 4) includes MOD field 742 (bits [7-6]), Reg field 744 (bits [5-3]), and R/M field 746 (bits [2-0]). The role of Reg field 744 may include the following: encoding either the destination register operand or a source register operand (the rrr of Rrrr), or be treated as an opcode extension and not used to encode any instruction operand. The role of R/M field 746 may include the following: encoding the instruction operand that references a memory address, or encoding either the destination register operand or a source register operand.

Scale, Index, Base (SIB)—The content of Scale field 750 (Byte 5) includes SS752 (bits [7-6]), which is used for memory address generation. The contents of SIB.xxx 754 (bits [5-3]) and SIB.bbb 756 (bits [2-0]) have been previously referred to with regard to the register indexes Xxxx and Bbbb.

The Displacement Field 762 and the immediate field (IMM8) 772 contain data.

### Exemplary Register Architecture

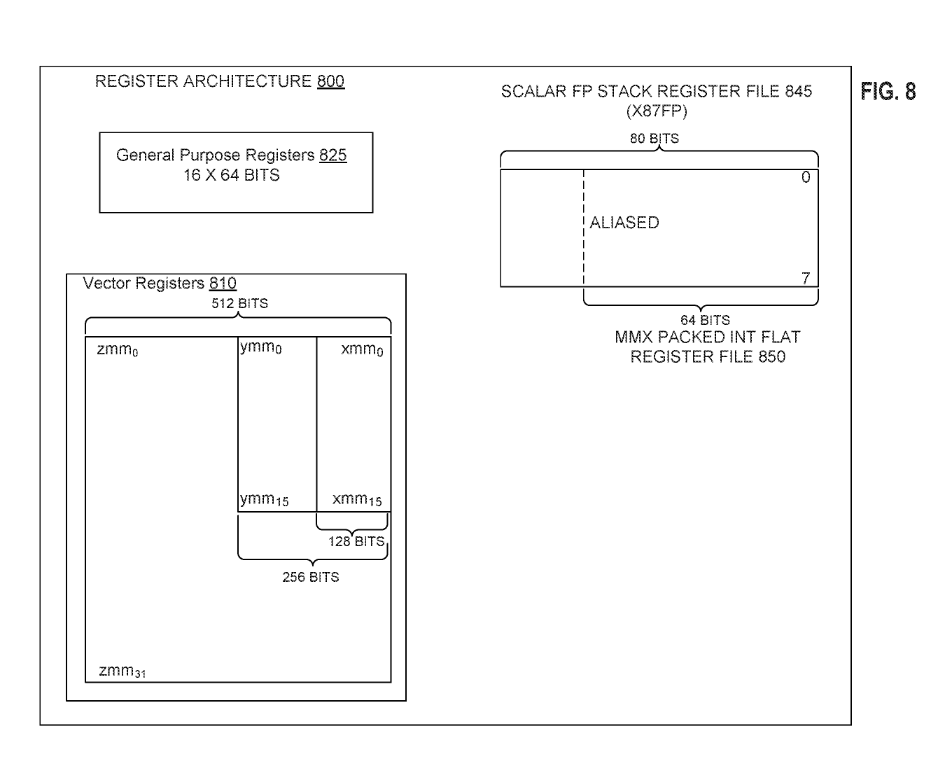

FIG. 8 is a block diagram of a register architecture 800 according to one embodiment of the invention. In the embodiment illustrated, there are 32 vector registers 810 that are 512 bits wide; these registers are referenced as zmm0 through zmm31. The lower order 256 bits of the lower 11 zmm registers are overlaid on registers ymm0-15. The lower order 128 bits of the lower 11 zmm registers (the lower order 128 bits of the ymm registers) are overlaid on registers xmm0-15.

General-purpose registers 825—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 845, on which is aliased the MMX packed integer flat register file 850—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures. Detailed herein are circuits (units) that comprise exemplary cores, processors, etc.

### Exemplary Core Architectures

In-Order and Out-of-Order Core Block Diagram

FIG. 9A is a block diagram illustrating both an exemplary in-order pipeline and an exemplary register renaming, out-of-order issue/execution pipeline according to embodiments of the invention. FIG. 9B is a block diagram illustrating both an exemplary embodiment of an in-order architecture core and an exemplary register renaming, out-of-order issue/execution architecture core to be included in a processor according to embodiments of the invention. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, a length-decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 9B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

FIGS. 10A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 10A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1024-bits wide per direction in some embodiments.

FIG. 10B is an expanded view of part of the processor core in FIG. 10A according to embodiments of the invention. FIG. 10B includes an L1 data cache 1006A part of the L1 cache 1004, as well as more detail regarding the vector unit 1010 and the vector registers 1014. Specifically, the vector unit 1010 is a 11-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input.

Processor with Integrated Memory Controller and Graphics

FIG. 11 is a block diagram of a processor 1100 that may have more than one core, may have an integrated memory controller, and may have integrated graphics according to embodiments of the invention. The solid lined boxes in FIG. 11 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of cache within the cores 1104A-N, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

Exemplary Computer Architectures

FIGS. 12-15 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 12, shown is a block diagram of a system 1200 in accordance with one embodiment of the present invention. The system 1200 may include one or more processors 1210, 1215, which are coupled to a controller hub 1220. In one embodiment, the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 is couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 12 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface, or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 12155 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

Referring now to FIG. 13, shown is a block diagram of a first more specific exemplary system 1300 in accordance with an embodiment of the present invention. As shown in FIG. 13, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes, as part of its bus controller units, point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 13, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1392. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another I/O interconnect bus, although the scope of the present invention is not so limited.

As shown in FIG. 13, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1316. Note that other architectures are possible. For example, instead of the point-to-point architecture of FIG. 13, a system may implement a multi-drop bus or other such architecture.

Referring now to FIG. 14, shown is a block diagram of a second more specific exemplary system 1400 in accordance with an embodiment of the present invention. Like elements in FIGS. 13 and 14 bear like reference numerals, and certain aspects of FIG. 13 have been omitted from FIG. 14 in order to avoid obscuring other aspects of FIG. 14.

FIG. 14 illustrates that the processors 1370, 1380 may include integrated memory and I/O control logic (“CL”) 1472 and 1482, respectively. Thus, the CL 1472, 1482 include integrated memory controller units and include I/O control logic. FIG. 14 illustrates that not only are the memories 1332, 1334 coupled to the CL 1372, 1382, but also that I/O devices 1414 are also coupled to the control logic 1372, 1382. Legacy I/O devices 1415 are coupled to the chipset 1390.

Referring now to FIG. 15, shown is a block diagram of a SoC 1500 in accordance with an embodiment of the present invention. Similar elements in FIG. 11 bear like reference numerals. Also, dashed lined boxes are optional features on more advanced SoCs. In FIG. 15, an interconnect unit(s) 1502 is coupled to: an application processor 1510 which includes a set of one or more cores 152A-N, cache units 1104A-N, and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 13, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products. Emulation (including binary translation, code morphing, etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 16 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 16 shows a program in a high level language 1602 may be compiled using a first compiler 1604 to generate a first binary code (e.g., x86) 1606 that may be natively executed by a processor with at least one first instruction set core 1616. In some embodiments, the processor with at least one first instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The first compiler 1604 represents a compiler that is operable to generate binary code of the first instruction set 1606 (e.g., object code) that can, with or without additional linkage processing, be executed on the processor with at least one first instruction set core 1616. Similarly, FIG. 16 shows the program in the high level language 1602 may be compiled using an alternative instruction set compiler 1608 to generate alternative instruction set binary code 1610 that may be natively executed by a processor without at least one first instruction set core 1614 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1612 is used to convert the first binary code 1606 into code that may be natively executed by the processor without a first instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have a first instruction set processor or core to execute the first binary code 1606.

### Further Examples

Example 1 provides a processor including: fetch circuitry to fetch an instruction having an opcode, an order, a destination identifier, and N source identifiers, N being equal to the order, and the order being one of two, three, and four, decode circuitry to decode the fetched instruction, execution circuitry, for each element of the identified destination, to: generate N squares by squaring each corresponding element of the N identified sources, and generate a sum of the N squares and previous contents of the element.

Example 2 includes the substance of the exemplary processor of Example 1, wherein the execution circuit uses a chain of N two-way fused multiply adders to generate the N squares and the sum.

Example 3 includes the substance of the exemplary processor of Example 1, wherein the execution circuit uses N two-input multipliers to generate the N squares in parallel, and uses a N-plus-one-input adder to generate the sum.

Example 4 includes the substance of the exemplary processor of Example 1, wherein the order is specified by one the opcode, an opcode prefix, an opcode suffix, and an immediate.

Example 5 includes the substance of the exemplary processor of Example 1, wherein each element of the identified destination and the N identified sources includes a fixed size, the instruction further including a precision operand to specify the fixed size.

Example 6 includes the substance of the exemplary processor of Example 1, wherein each element of the identified destination and the N identified sources includes a floating point value.

Example 7 includes the substance of the exemplary processor of Example 1, wherein the instruction further includes a writemask, the writemask being a multi-bit value with each bit to control, for each element of the identified destination, whether the sum is stored to the element.

Example 8 includes the substance of the exemplary processor of Example 1, wherein the destination identifier and the N source identifiers each specifies a vector register having a vector length, wherein the vector length includes one of 128 bits, 256 bits, and 512 bits, and wherein the instruction further specifies the vector length using one of the opcode, a prefix to the opcode, and an immediate.

Example 9 includes the substance of the exemplary processor of Example 1, wherein the identified destination is zeroed after reset.

Example 10 includes the substance of the exemplary processor of Example 1, wherein the execution circuit is to execute the decoded instruction over multiple cycles, processing a subset of the elements of the identified destination on each cycle.

Example 11 provides a method including: fetching, using fetch circuitry, an instruction having an opcode, an order, a destination identifier, and N source identifiers, N being equal to the order, and the order being one of two, three, and four, decoding, using decode circuitry, the fetched instruction, executing, by execution circuitry, to, for each element of the identified destination: generate N squares by squaring each corresponding element of the N identified sources, and generate a sum of the N squares and previous contents of the element.

Example 12 includes the substance of the exemplary method of Example 11, further including using, by the execution circuit, a chain of N two-way fused multiply adders to generate the N squares and the sum.

Example 13 includes the substance of the exemplary method of Example 11, further including using, by the execution circuit, N two-input multipliers to generate the N squares in parallel, and a N-plus-one-input adder to generate the sum.

Example 14 includes the substance of the exemplary method of Example 11, wherein the order is specified by one the opcode, an opcode prefix, an opcode suffix, and an immediate.

Example 15 includes the substance of the exemplary method of Example 11, wherein each element of the identified destination and the N identified sources includes a fixed size, the instruction further including a precision operand to specify the fixed size.

Example 16 includes the substance of the exemplary method of Example 11, wherein each element of the identified destination and the N identified sources includes a floating point value.

Example 17 includes the substance of the exemplary method of claim 11, wherein the instruction further includes a writemask, the writemask being a multi-bit value with each bit to control, for each element of the identified destination, whether the sum is stored to the element.

Example 18 includes the substance of the exemplary method of Example 11, wherein the destination identifier and the N source identifiers each specifies a vector register having a vector length, wherein the vector length includes one of 128 bits, 256 bits, and 512 bits, and wherein the instruction further specifies the vector length using one of the opcode, a prefix to the opcode, and an immediate.

Example 19 includes the substance of the exemplary method of Example 11, wherein the identified destination is zeroed after reset.

Example 20 includes the substance of the exemplary method of Example 11, wherein the execution circuit is to execute the decoded instruction over multiple cycles, processing a subset of the elements of the identified destination on each cycle.

Example 21 provides an apparatus including: means for fetching an instruction having an opcode, an order, a destination identifier, and N source identifiers, N being equal to the order, and the order being one of two, three, and four, means for decoding the fetched instruction, means for executing to, for each element of the identified destination: generate N squares by squaring each corresponding element of the N identified sources, and generate a sum of the N squares and previous contents of the element.

Example 22 includes the substance of the exemplary apparatus of Example 21, wherein the means for executing uses a chain of N two-way fused multiply adders to generate the N squares and the sum.

Example 23 includes the substance of the exemplary apparatus of Example 21, wherein the means for executing uses N two-input multipliers to generate the N squares in parallel, and uses a N-plus-one-input adder to generate the sum.

Example 24 includes the substance of the exemplary apparatus of Example 21, wherein the order is specified by one the opcode, an opcode prefix, an opcode suffix, and an immediate.

Example 25 includes the substance of the exemplary apparatus of Example 21, wherein each element of the identified destination and the N identified sources includes a fixed size, the instruction further including a precision operand to specify the fixed size.

Example 26 includes the substance of the exemplary apparatus of Example 21, wherein each element of the identified destination and the N identified sources includes a floating point value.

Example 27 includes the substance of the exemplary apparatus of Example 21, wherein the instruction further includes a writemask, the writemask being a multi-bit value with each bit to control, for each element of the identified destination, whether the sum is stored to the element.

Example 28 includes the substance of the exemplary apparatus of Example 21, wherein the destination identifier and the N source identifiers each specifies a vector register having a vector length, wherein the vector length includes one of 2128 bits, 256 bits, and 512 bits, and wherein the instruction further specifies the vector length using one of the opcode, a prefix to the opcode, and an immediate.

Example 29 includes the substance of the exemplary apparatus of Example 21, wherein the identified destination is zeroed after reset.

Example 30 includes the substance of the exemplary apparatus of Example 21, wherein the execution circuit is to execute the decoded instruction over multiple cycles, processing a subset of the elements of the identified destination on each cycle.

Example 31 provides a non-transitory computer-readable medium containing instructions that, when execute by a processor, cause the processor to: fetch, using fetch circuitry, an instruction having an opcode, an order, a destination identifier, and N source identifiers, N being equal to the order, and the order being one of two, three, and four, decode, using decode circuitry, the fetched instruction, execute, by execution circuitry, to, for each element of the identified destination: generate N squares by squaring each corresponding element of the N identified sources, and generate a sum of the N squares and previous contents of the element.

Example 32 includes the substance of the exemplary non-transitory computer-readable medium of Example 31, further including using, by the execution circuit, a chain of N two-way fused multiply adders to generate the N squares and the sum.

Example 33 includes the substance of the exemplary non-transitory computer-readable medium of Example 31, further including using, by the execution circuit, N two-input multipliers to generate the N squares in parallel, and a N-plus-one-input adder to generate the sum.

Example 34 includes the substance of the exemplary non-transitory computer-readable medium of Example 31, wherein the order is specified by one the opcode, an opcode prefix, an opcode suffix, and an immediate.

Example 35 includes the substance of the exemplary non-transitory computer-readable medium of Example 31, wherein each element of the identified destination and the N identified sources includes a fixed size, the instruction further including a precision operand to specify the fixed size.

Example 36 includes the substance of the exemplary non-transitory computer-readable medium of Example 31, wherein each element of the identified destination and the N identified sources includes a floating point value.

Example 37 includes the substance of the exemplary non-transitory computer-readable medium of Example 31, wherein the instruction further includes a writemask, the writemask being a multi-bit value with each bit to control, for each element of the identified destination, whether the sum is stored to the element.

Example 38 includes the substance of the exemplary non-transitory computer-readable medium of Example 31, wherein the destination identifier and the N source identifiers each specifies a vector register having a vector length, wherein the vector length includes one of 128 bits, 256 bits, and 512 bits, and wherein the instruction further specifies the vector length using one of the opcode, a prefix to the opcode, and an immediate.

Example 39 includes the substance of the exemplary non-transitory computer-readable medium of Example 31, wherein the identified destination is zeroed after reset.

Example 40 includes the substance of the exemplary non-transitory computer-readable medium of Example 31, wherein the execution circuit is to execute the decoded instruction over multiple cycles, processing a subset of the elements of the identified destination on each cycle.

What is claimed is:

1. A processor comprising:
fetch circuitry to fetch an instruction having an opcode, an order, a destination identifier, and N source identifiers, N being equal to the order, and the order being one of two, three, and four;
decode circuitry to decode the fetched instruction; and
execution circuitry, for each element of the identified destination, to:
generate N squares by squaring each corresponding element of the N identified sources; and
generate a sum of the N squares and previous contents of the element.

2. The processor of claim 1, wherein the execution circuitry uses a chain of N two-way fused multiply adders to generate the N squares and the sum.

3. The processor of claim 1, wherein the execution circuitry uses N two-input multipliers to generate the N squares in parallel, and uses a N-plus-one-input adder to generate the sum.

4. The processor of claim 1, wherein the order is specified by one of the opcode, an opcode prefix, an opcode suffix, and an immediate.

5. The processor of claim 1, wherein each element of the identified destination and the N identified sources comprises a fixed size, the instruction further comprising a precision operand to specify the fixed size.

6. The processor of claim 1, wherein each element of the identified destination and the N identified sources comprises a floating point value.

7. The processor of clam 1, wherein the instruction further comprises a writemask, the writemask being a multi-bit value with each bit to control, for each element of the identified destination, whether the sum is stored to the element.

8. The processor of claim 1, wherein the destination identifier and the N source identifiers each specifies a vector register having a vector length, wherein the vector length is selected from a group consisting of 128 bits, 256 bits, and 512 bits, and wherein the instruction further specifies the vector length using one of the opcode, a prefix to the opcode, and an immediate.

9. The processor of claim 1, wherein the identified destination is zeroed after reset.

10. The processor of claim 1, wherein the execution circuit is to execute the decoded instruction over multiple cycles, processing a subset of the elements of the identified destination on each cycle.

11. A method comprising:
fetching, using fetch circuitry, an instruction having an opcode, an order, a destination identifier, and N source identifiers, N being equal to the order, and the order being one of two, three, and four;
decoding, using decode circuitry, the fetched instruction; and
executing, by execution circuitry, to, for each element of the identified destination:
generate N squares by squaring each corresponding element of the N identified sources; and
generate a sum of the N squares and previous contents of the element.

12. The method of claim 11, further comprising using, by the execution circuit, a chain of N two-way fused multiply adders to generate the N squares and the sum.

13. The method of claim 11, further comprising using, by the execution circuit, N two-input multipliers to generate the N squares in parallel, and a N-plus-one-input adder to generate the sum.

14. The method of claim 11, wherein the order is specified by one the opcode, an opcode prefix, an opcode suffix, and an immediate.

15. The method of claim 11, wherein each element of the identified destination and the N identified sources comprises a fixed size, the instruction further comprising a precision operand to specify the fixed size.

16. An apparatus comprising:
means for fetching an instruction having an opcode, an order, a destination identifier, and N source identifiers, N being equal to the order, and the order being one of two, three, and four;
means for decoding the fetched instruction; and
means for executing to, for each element of the identified destination:
generate N squares by squaring each corresponding element of the N identified sources; and
generate a sum of the N squares and previous contents of the element.

17. The apparatus of claim 16, wherein the means for executing uses a chain of N two-way fused multiply adders to generate the N squares and the sum.

18. The apparatus of claim 16, wherein the means for executing uses N two-input multipliers to generate the N squares in parallel, and uses a N-plus-one-input adder to generate the sum.

19. The apparatus of claim 16, wherein the order is specified by one the opcode, an opcode prefix, an opcode suffix, and an immediate.

20. The apparatus of claim 16, wherein each element of the identified destination and the N identified sources comprises a fixed size, the instruction further comprising a precision operand to specify the fixed size.

21. A non-transitory computer-readable medium containing instructions that, when execute by a processor, cause the processor to:
fetch, using fetch circuitry, an instruction having an opcode, an order, a destination identifier, and N source identifiers, N being equal to the order, and the order being one of two, three, and four;
decode, using decode circuitry, the fetched instruction; and
execute, by execution circuitry, to, for each element of the identified destination:
generate N squares by squaring each corresponding element of the N identified sources; and
generate a sum of the N squares and previous contents of the element.

22. The non-transitory computer-readable medium of claim 21, further comprising using, by the execution circuit, a chain of N two-way fused multiply adders to generate the N squares and the sum.

23. The non-transitory computer-readable medium of claim 21, further comprising using, by the execution circuit, N two-input multipliers to generate the N squares in parallel, and a N-plus-one-input adder to generate the sum.

24. The non-transitory computer-readable medium of claim 21, wherein the order is specified by one the opcode, an opcode prefix, an opcode suffix, and an immediate.

25. The non-transitory computer-readable medium of claim 21, wherein each element of the identified destination and the N identified sources comprises a fixed size, the instruction further comprising a precision operand to specify the fixed size.
